(19) United States
(12) Patent Application Publication
(10) Pub. No.: US 2009/0004568 A1
(43) Pub. Date: Jan. 1, 2009

(54) ANODE AND BATTERY

(75) Inventors: Takakazu Hirose, Fukushima (JP); Hideki Nakai, Fukushima (JP); Momoe Adachi, Tokyo (JP); Hiroyuki Yamaguchi, Fukushima (JP); Kenichi Kawase, Fukushima (JP); Tadahiko Kubota, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/127,457

(22) Filed: May 27, 2008

(30) Foreign Application Priority Data
May 28, 2007 (JP) 2007-140134

(51) Int. Cl. H01M 4/00; H01M 4/58

(52) U.S. Cl. 429/221; 429/218.1

(57) ABSTRACT

A battery capable of improving the cycle characteristics is provided. The battery includes a cathode, an anode and an electrolytic solution. The anode has an anode current collector, an anode active material layer provided on the anode current collector, and a coat provided on the anode active material layer, in which the coat contains a fluorine resin having an ether bond.

### CROSS REFERENCES TO RELATED APPLICATIONS

The present invention contains subject matter related to Japanese Patent Application JP2007-140134 filed in the Japanese Patent Office on May 28, 2007, the entire contents of which being incorporated herein by reference.

### BACKGROUND OF THE INVENTION

1. Field of the Invention

The present invention relates to an anode having an anode current collector and an anode active material layer provided thereon and a battery including it.

2. Description of the Related Art

In recent years, portable electronic devices such as combination cameras (videotape recorder), mobile phones, and notebook personal computers have been widely used, and it is strongly demanded to reduce their size and weight and to achieve their long life. Accordingly, as a power source for the portable electronic devices, a battery, in particular a light-weight secondary batter capable of providing a high energy density has been developed. Specially, a secondary battery using insertion and extraction of lithium for charge and discharge reaction (so-called lithium ion secondary battery) is extremely prospective, since such a secondary battery provides a higher energy density compared to a lead battery and a nickel cadmium battery.

The lithium ion secondary battery has a cathode, an anode, and an electrolytic solution. The anode has an anode current collector and an anode active material layer provided thereon. As an anode active material contained in the anode active material layer, a carbon material has been widely used. However, in recent years, as the high performance and the multi functions of the portable electronic devices are developed, further improvement in the battery capacity is demanded. Thus, it has been considered to use silicon, tin or the like instead of the carbon material. Since the theoretical capacity of silicon (4199 mAh/g) and the theoretical capacity of tin (994 mAh/g) are significantly higher than the theoretical capacity of graphite (372 mAh/g), it is prospected that the battery capacity is thereby highly improved.

However, when silicon or the like is used as the anode active material, the anode active material inserting lithium is highly activated. Thus, the electrolytic solution is easily decomposed in charge and discharge, and lithium is easily inactivated. Thereby, in this case, while a high capacity is obtained, the cycle characteristics as important characteristics of the secondary battery tend to be lowered when charge and discharge are repeated.

Therefore, to improve the cycle characteristics even when silicon or the like is used as the anode active material, various devices have been invented. Specifically, a technique to cover the anode active material with a polymer material such as polyvinylidene fluoride has been proposed (for example, refer to Japanese Unexamined Patent Application Publication Nos. 2006-517719 and 2004-185810). Further, as a related technique, a technique using a polymer material such as polyvinylidene fluoride as a binder of the anode has been proposed (for example, refer to Japanese Unexamined Patent Application Publication Nos. 2005-063731 and 2005-063767).

### SUMMARY OF THE INVENTION

The recent portable electronic devices increasingly tend to become small, and the high performance and the multi functions thereof tend to be increasingly developed. Accordingly, there is a tendency that charge and discharge of the secondary battery are frequently repeated, and thus the cycle characteristics are easily lowered. In particular, in the lithium ion secondary battery in which silicon or the like is used as the anode active material to attain a high capacity, the cycle characteristics are easily lowered significantly. Thus, further improvement of the cycle characteristics of the secondary battery is aspired.

In view of the foregoing, in the invention, it is desirable to provide an anode and a battery capable of improving the cycle characteristics.

According to an embodiment of the invention, there is provided an anode including an anode current collector, an anode active material layer provided on the anode current collector, and a coat provided on the anode active material layer, in which the coat contains a fluorine resin having an ether bond.

According to an embodiment of the invention, there is provided a battery including a cathode, an anode, and an electrolytic solution, in which the anode has an anode current collector, an active material layer provided on the anode current collector, and a coat provided on the anode active material layer, and the coat contains a fluorine resin having an ether bond.

The foregoing “fluorine resin having an ether bond” is a generic term used to refer to a polymer compound that has a structure including the main chain composed of a straight carbon chain (with/without the side chain), has the ether bond in such a structure, and has a fluorine group as a substitute group in such a structure. In this case, the ether bond may be located in the main chain, in the side chain, or in both the main chain and the side chain. The fluorine group may be located in the main chain, in the side chain, or in both the main chain and the side chain. It is needless say that in the case where the main chain has both the ether bond and the fluorine bond, it is possible that no side chain exists.

According to the anode of the embodiment of the invention, the coat provided on the anode active material layer contains the fluorine resin having an ether bond. In this case, compared to a case that the coat is not provided or a case that the coat is provided but the fluorine resin does not have an ether bond, the chemical stability is improved even in the case where the anode active material layer contains a highly active anode active material. Thereby, according to the battery including the anode of the embodiment of the invention, even when charge and discharge are repeated, the electrolytic solution is hardly decomposed, and thus the cycle characteristics may be improved.

In particular, when the surface of the coat has a fluoride particle of an electrode reactant, or when the coat is an oil film having a cross-linked structure between adjacent anode active material particles, higher effects may be obtained. In this case, when the number of fluoride particles of the electrode reactant per 1 particle of the anode active material particle is in the range from 4 to 500, higher effects may be obtained.

Further, when the anode active material contains oxygen and a content of the oxygen in the anode active material is in the range from 3 atomic % to 40 atomic %; when the anode active material contains at least one metal element selected from the group consisting of iron, cobalt, nickel, titanium, chromium, and molybdenum; when the anode active material has an oxygen-containing region (region in which oxygen is contained and a content of the oxygen therein is higher than a content of oxygen in other regions) in the thickness direction; or when ten points average height of roughness profile Rz of a surface of the anode current collector is in the range from 1.5 μm to 6.5 μm, higher effects may be obtained.

Further, when the anode active material layer contains a metal not being alloyed with the electrode reactant, higher effects may be obtained. In this case, when ratio M2/M1 of the number of moles M2 per unit area of the metal in relation to the number of moles M1 per unit area of the anode active material particles is in the range from 1/15 to 7/1, higher effects may be obtained.

Other and further objects, features and advantages of the invention will appear more fully from the following description.

### BRIEF DESCRIPTION OF THE DRAWINGS

FIG. 1 is a cross section showing a structure of an anode according to an embodiment of the invention;

FIGS. 2A and 2B are an SEM photograph showing a cross sectional structure of the anode current collector and the anode active material layer shown in FIG. 1 and a schematic drawing thereof;

FIGS. 3A and 3B are an SEM photograph showing a particle structure of the surface of the anode active material layer shown in FIG. 1 and a schematic drawing thereof;

FIGS. 4A and 4B are an SEM photograph showing a cross sectional structure of the anode active material layer shown in FIGS. 3A and 3B and a schematic drawing thereof;

FIGS. 5A and 5B are an SEM photograph showing an enlarged part of the surface of the anode shown in FIG. 1 and a schematic drawing thereof;

FIGS. 6A to 6C are another SEM photographs showing an enlarged part of the surface of the anode shown in FIG. 1 and a schematic drawing thereof;

FIGS. 7A to 7C are still another SEM photographs showing an enlarged part of the surface of the anode shown in FIG. 1 and a schematic drawing thereof;

FIGS. 8A and 8B are an SEM photograph showing another cross sectional structure of the anode current collector and the anode active material layer shown in FIG. 1 and a schematic drawing thereof;

FIG. 9 is a cross section showing a structure of a first battery including the anode according to the embodiment of the invention;

FIG. 10 is a cross section taken along line X-X of the first battery shown in FIG. 9;

FIG. 11 is a cross section showing an enlarged part of the anode shown in FIG. 10;

FIG. 12 is a cross section showing a structure of a second battery including the anode according to the embodiment of the invention;

FIG. 13 is a cross section showing an enlarged part of the spirally wound electrode body shown in FIG. 12;

FIG. 14 is a cross section showing a structure of a third battery including the anode according to the embodiment of the invention;

FIG. 15 is a cross section taken along line XV-XV of the spirally wound electrode body shown in FIG. 14;

FIG. 16 is a cross section showing an enlarged part of the anode shown in FIG. 16;

FIG. 17 is a diagram showing a correlation between the number of fluoride particles and a discharge capacity retention ratio (type of fluorine resin: Chemical formula 1; the number of layers of anode active material particle: 1);

FIG. 18 is a diagram showing a correlation between the number of fluoride particles and a discharge capacity retention ratio (type of fluorine resin: Chemical formula 1; the number of layers of anode active material particle: 6);

FIG. 19 is a diagram showing a correlation between the number of fluoride particles and a discharge capacity retention ratio (type of fluorine resin: Chemical formula 6; the number of layers of anode active material particle: 1);

FIG. 20 is a diagram showing measurement results of element bonding state (carbon bond before charge and discharge) by XPS;

FIG. 21 is a diagram showing measurement results of element bonding state (fluorine bond before charge and discharge) by XPS;

FIG. 22 is a diagram showing measurement results of element bonding state (carbon bond after charge and discharge) by XPS;

FIG. 23 is a diagram showing measurement results of element bonding state (fluorine bond after charge and discharge) by XPS;

FIGS. 24A to 24D are diagrams showing measurement results of element distribution state (before charge and discharge) by XPS;

FIGS. 25A to 25D are diagrams showing measurement results of element distribution state (after charge and discharge) by XPS;

FIG. 26 is a diagram showing a correlation between an oxygen content and a discharge capacity retention ratio;

FIG. 27 is a diagram showing a correlation between the number of second oxygen-containing regions and a discharge capacity retention ratio;

FIG. 28 is a diagram showing a correlation between ten points average height of roughness profile Rz and a discharge capacity retention ratio; and

FIG. 29 is a diagram showing a correlation between molar ratio M2/M1 and a discharge capacity retention ratio.

### DETAILED DESCRIPTION OF THE PREFERRED EMBODIMENT

An embodiment of the invention will be hereinafter described in detail with reference to the drawings.

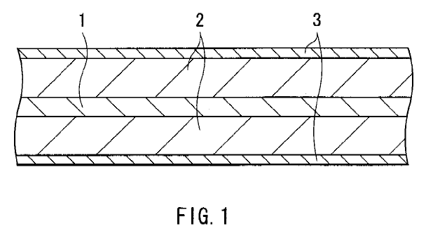

FIG. 1 shows a cross sectional structure of an anode according to an embodiment of the invention. The anode is used, for example, for an electrochemical device such as a battery. The anode has an anode current collector 1 having a pair of opposed faces, an anode active material layer 2 provided on the anode current collector 1, and a coat 3 provided on the anode active material layer 2. Since the anode has the coat 3, the chemical stability of the anode is improved, and thus even in the case where the anode active material layer 2 contains a highly active anode active material, such an anode active material is hardly reacted with other substance. Such “other substance” includes, for example, an electrolytic solution in the case that the anode is used for a battery and the like.

The anode current collector 1 is preferably made of a metal material having favorable electrochemical stability, a favorable electric conductivity, and a favorable mechanical strength. As the metal material, for example, copper, nickel, stainless or the like is cited. Specially, copper is preferable since a high electric conductivity is thereby obtained.

In particular, the metal material composing the anode current collector 1 preferably contains one or more metal elements not forming an intermetallic compound with an electrode reactant (for example, lithium or the like). If the intermetallic compound is formed with the electrode reactant, lowering of the current collectivity and separation of the anode active material layer 2 from the anode current collector 1 may occur, being affected by a stress due to expansion and shrinkage of the anode active material layer 2 while the electrochemical device is operated (for example, when a battery is charged and discharged). As the foregoing metal element, for example, copper, nickel, titanium, iron, chromium or the like is cited.

The foregoing metal material preferably contains one or more metal elements being alloyed with the anode active material layer 2. Thereby, the contact characteristics between the anode current collector 1 and the anode active material layer 2 are improved, and thus the anode active material layer 2 is hardly separated from the anode current collector 1. As a metal element that does not form an intermetallic compound with the electrode reactant and is alloyed with the anode active material layer 2, for example, in the case that the anode active material contained in the anode active material layer 2 contains silicon, copper, nickel, iron or the like is cited. These metal elements are preferable in terms of the strength and the electric conductivity.

The anode current collector 1 may have a single layer structure or a multilayer structure. In the case where the anode current collector 1 has the multilayer structure, it is preferable that the layer adjacent to the anode active material layer 2 is made of a metal material being alloyed with the anode active material layer 2, and layers not adjacent to the anode active material layer 2 are made of other metal material.

The surface of the anode current collector 1 is preferably roughened. Thereby, due to the so-called anchor effect, the contact characteristics between the anode current collector 1 and the anode active material layer 2 are improved. In this case, it is enough that at least the surface of the anode current collector 1 opposed to the anode active material layer 2 is roughened. As a roughening method, for example, a method of forming fine particles by electrolytic treatment and the like are cited. The electrolytic treatment is a method of providing roughened surface by forming fine particles on the surface of the anode current collector 1 by electrolytic method in an electrolytic bath. A copper foil provided with the electrolytic treatment is generally called “electrolytic copper foil.”

Ten points average height of roughness profile Rz of the surface of the anode current collector 1 is preferably in the range from 1.5 μm to 6.5 μm, since thereby the contact characteristics between the anode current collector 1 and the anode active material layer 2 are more improved. Specifically, if the ten points average height of roughness profile Rz is smaller than 1.5 μm, there is a possibility that sufficient contact characteristics are not able to be obtained. Meanwhile, if the ten points average height of roughness profile Rz is larger than 6.5 μm, there is a possibility that many holes are included in the anode active material and thereby the surface area is increased.

The anode active material layer 2 contains one or more anode materials capable of inserting and extracting an electrode reactant as an anode active material, and may also contain other materials such as a conductive agent and a binder according to needs. The anode active material layer 2 may be provided on the both faces of the anode current collector 1, or may be provided on a single face of the anode current collector 1.

As the anode material capable of inserting and extracting the electrode reactant, for example, a material that is capable of inserting and extracting the electrode reactant and contains at least one of metal elements and metalloid elements as an element is cited. Such an anode material is preferably used, since a high energy density is thereby obtained. Such an anode material may be a simple substance, an alloy, or a compound of a metal element or a metalloid element, or may have one or more phases thereof at least in part. In the invention, “the alloy” includes an alloy containing one or more metal elements and one or more metalloid elements, in addition to an alloy composed of two or more metal elements. Further, “the alloy” may contain a nonmetallic element. The texture thereof includes a solid solution, a eutectic crystal (eutectic mixture), an intermetallic compound, and a texture in which two or more thereof coexist.

As such a metal element or such a metalloid element composing the anode material, for example, a metal element or a metalloid element capable of forming an alloy with the electrode reactant is cited. Specifically, magnesium (Mg), boron, aluminum (Al), gallium (Ga), indium (In), silicon, germanium (Ge), tin, lead (Pb), bismuth (Bi), cadmium (Cd), silver (Ag), zinc, hafnium (Hf), zirconium (Zr), yttrium (Y), palladium (Pd), platinum (Pt) and the like is cited. Specially, at least one of silicon and tin is preferably used. Silicon and tin have the high ability to insert and extract the electrode reactant, and thus provide a high energy density.

As an anode material containing at least one of silicon and tin, for example, the simple substance, an alloy, or a compound of silicon; the simple substance, an alloy, or a compound of tin; or a material having one or more phases thereof at least in part is cited. Each thereof may be used singly, or a plurality thereof may be used by mixture.

As the alloy of silicon, for example, an alloy containing at least one selected from the group consisting of tin, nickel, copper, iron, cobalt, manganese, zinc, indium, silver, titanium, germanium, bismuth, antimony, and chromium as the second element other than silicon is cited. As the compound of silicon, for example, a compound containing oxygen or carbon (C) is cited, and may contain the foregoing second element in addition to silicon. Examples of an alloy or a compound of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), LiSiO and the like are cited.

As the alloy of tin, for example, an alloy containing at least one selected from the group consisting of silicon, nickel, copper, iron, cobalt, manganese, zinc, indium, silver, titanium, germanium, bismuth, antimony, and chromium as the second element other than tin is cited. As the compound of tin, for example, a compound containing oxygen or carbon is cited, and may contain the foregoing second element in addition to silicon. Examples of an alloy or a compound of tin include SnSiO₃, LiSnO, Mg₂Sn and the like.

In particular, as the anode material containing at least one of silicon and tin, for example, an anode material containing the second element and the third element in addition to tin as the first element is preferable. As the second element, at least one selected from the group consisting of cobalt, iron, magnesium, titanium, vanadium (V), chromium, manganese, nickel, copper, zinc, gallium, zirconium, niobium (Nb), molybdenum, silver, indium, cerium (Ce), hafnium, tantalum (Ta), tungsten (W), bismuth, and silicon is cited. As the third element, at least one selected from the group consisting of boron, carbon, aluminum, and phosphorus (P) is cited. When the second element and the third element are contained, the cycle characteristics are improved.

Specially, a SnCoC-containing material that contains tin, cobalt, and carbon as an element in which the carbon content is in the range from 9.9 wt % to 29.7 wt %, and the cobalt ratio to the total of tin and cobalt (Co/(Sn+Co)) is in the range from 30 wt % to 70 wt % is preferable. In such a composition range, a high energy density is obtained.

The SnCoC-containing material may further contain other element according to needs. As other element, for example, silicon, iron, nickel, chromium, indium, niobium, germanium, titanium, molybdenum, aluminum, phosphorus, gallium, bismuth or the like is preferable. Two or more thereof may be contained, since thereby higher effects is obtained.

The SnCoC-containing material has a phase containing tin, cobalt, and carbon. Such a phase preferably has a low crystallinity structure or an amorphous structure. Further, in the SnCoC-containing material, at least part of carbon as an element is preferably bonded to a metal element or a metalloid element as other element. Cohesion or crystallization of tin or the like is thereby inhibited.

The SnCoC-containing material may be formed by, for example, mixing raw materials of each element, dissolving the resultant mixture in an electric furnace, a high frequency induction furnace, an arc melting furnace or the like and then solidifying the resultant. Otherwise, the SnCoC-containing material may be formed by various atomization methods such as gas atomizing and water atomizing; various roll methods; or a method using mechanochemical reaction such as mechanical alloying method and mechanical milling method. Specially, the SnCoC-containing material is preferably formed by the method using mechanochemical reaction, since thereby the anode active material may have a low crystalline structure or an amorphous structure. For the method using the mechanochemical reaction, for example, a manufacturing apparatus such as a planetary ball mill apparatus and an attliter is used.

As a measurement method for examining bonding state of elements, for example, X-ray Photoelectron Spectroscopy (XPS) is cited. In XPS, in the case of graphite, the peak of 1s orbit of carbon (C1s) is observed at 284.5 eV in the apparatus in which energy calibration is made so that the peak of 4f orbit of gold atom (Au4f) is obtained in 84.0 eV. In the case of surface contamination carbon, the peak is observed at 284.8 eV. Meanwhile, in the case of higher electric charge density of carbon element, for example, when carbon is bonded to a metal element or a metalloid element, the peak of C1s is observed in the region lower than 284.5 eV. That is, when the peak of the composite wave of C1s obtained for the SnCoC-containing material is observed in the region lower than 284.5 eV, at least part of carbon contained in the SnCoC-containing material is bonded to the metal element or the metalloid element as other element.

In XPS, for example, the peak of C1s is used for correcting the energy axis of spectrums. Since surface contamination carbon generally exists on the surface, the peak of C1s of the surface contamination carbon is set to in 284.8 eV, which is used as an energy reference. In XPS, the waveform of the peak of C1s is obtained as a form including the peak of the surface contamination carbon and the peak of carbon in the SnCoC-containing material. Therefore, for example, by performing analysis by using commercially available software, the peak of the surface contamination carbon and the peak of carbon in the SnCoC-containing material are separated. In the analysis of the waveform, the position of the main peak existing on the lowest bound energy side is set to the energy reference (284.8 eV).

The anode active material layer 2 using the simple substance, an alloy, or a compound of silicon; the simple substance, an alloy, or a compound of tin; or a material having one or more phases thereof at least in part as an anode material is preferably formed by, for example, vapor-phase deposition method, liquid-phase deposition method, spraying method, firing method, or a combination of two or more of these methods. The anode active material layer 2 and the anode current collector 1 are preferably alloyed in at least part of the interface thereof. Specifically, it is preferable that at the interface thereof, the element of the anode current collector 1 is diffused in the anode active material layer 2; or the element of the anode active material layer 2 is diffused in the anode current collector 1; or these elements are diffused in each other. Thereby, destruction due to expansion and shrinkage of the anode active material layer 2 associated with charge and discharge is inhibited, and the electron conductivity between the anode active material layer 2 and the anode current collector 1 is improved.

As vapor-phase deposition method, for example, physical deposition method or chemical deposition method is cited. Specifically, vacuum evaporation method, sputtering method, ion plating method, laser ablation method, thermal CVD (Chemical Vapor Deposition) method, plasma CVD method and the like is cited. As liquid-phase deposition method, a known technique such as electrolytic plating and electroless plating may be used. Firing method is, for example, a method in which a particulate anode active material mixed with a binder or the like is dispersed in a solvent and the anode current collector is coated with the resultant, and then heat treatment is provided at a temperature higher than the melting point of the binder or the like. For firing method, a known technique such as atmosphere firing method, reactive firing method, and hot press firing method is available as well.

In addition to the foregoing anode material, as the anode material capable of inserting and extracting the electrode reactant, for example, a carbon material is cited. As the carbon material, for example, graphitizable carbon, non-graphitizable carbon in which the spaing of (002) plane is 0.37 nm or more, graphite in which the spacing of (002) plane is 0.34 nm or less and the like are cited. More specifically, pyrolytic carbons, coke, glassy carbon fiber, an organic polymer compound fired body, activated carbon, carbon black or the like is cited. Of the foregoing, the coke includes pitch coke, needle coke, petroleum coke and the like. The organic polymer compound fired body is obtained by firing and carbonizing a phenol resin, a furan resin or the like at an appropriate temperature. In the carbon material, a change in the crystal structure due to insertion and extraction of the electrode reactant is very little. Therefore, for example, by using the carbon material together with other anode material, a high energy density is obtained and superior cycle characteristics are obtained. In addition, the carbon material also functions as an electrical conductor, and thus the carbon material is preferably used. The shape of the carbon material may be any of a fibrous shape, a spherical shape, a granular shape, and a scale-like shape.

Further, as the anode material capable of inserting and extracting the electrode reactant, for example, a metal oxide, a polymer compound and the like capable of inserting and extracting the electrode reactant are cited. It is needless to say that these anode materials may be used together with the above-mentioned anode material. As the metal oxide, for example, iron oxide, ruthenium oxide, molybdenum oxide or the like is cited. As the polymer compound, for example, polyacetylene, polyaniline, polypyrrole or the like is cited.

As the electrical conductor, for example, a carbon material such as graphite, carbon black, acetylene black, and Ketjen black is cited. Such a carbon material may be used singly, or two or more thereof may be used by mixture. The electrical conductor may be a metal material, a conductive polymer or the like as long as the material has the electric conductivity.

As the binder, for example, a synthetic rubber such as styrene-butadiene rubber, fluorinated rubber, and ethylene propylene diene; or a polymer material such as polyvinylidene fluoride is cited. One thereof may be used singly, or two or more thereof may be used by mixture.

The anode active material is linked to the anode current collector 1. The anode active material may be grown from the surface of the anode current collector 1 in the thickness direction of the anode active material layer 2. In this case, it is preferable that the anode active material is formed by vapor-phase deposition method, and at least part of the interface between the anode current collector 1 and the anode active material layer 2 is preferably alloyed.

The anode active material may be composed of a plurality of particles. The anode active material may have a single layer structure by being formed through a single deposition step. Otherwise, the anode active material may have a multilayer structure in the particle by being formed through a plurality of deposition steps. However, to prevent the anode current collector 1 from being damaged thermally when the anode active material is formed by evaporation method or the like associated with high heat in the deposition step, the anode active material preferably has the multilayer structure. When the deposition step of the anode active material is divided into several steps (the anode active material is sequentially formed and deposited), time that the anode current collector 1 is exposed at high heat is reduced compared to a case that the anode active material is formed by a single deposition step.

In particular, the anode active material preferably contains oxygen as an element, since thereby expansion and shrinkage of the anode active material layer 2 are inhibited. In the anode active material layer 2, in the case where the anode active material contains silicon, at least part of oxygen is preferably bonded to part of silicon. In this case, the bonding state may be in the form of silicon monoxide, silicon dioxide, or in the form of other metastable state.

The oxygen content in the anode active material is preferably in the range from 3 atomic % to 40 atomic %, since thereby higher effects are obtained. Specifically, if the oxygen content is smaller than 3 atomic %, there is a possibility that expansion and shrinkage of the anode active material layer 2 are not sufficiently inhibited. Meanwhile, if the oxygen content is larger than 40 atomic %, the resistance may be excessively increased. In the case where the anode is used together with an electrolytic solution in an electrochemical device, the anode active material does not include a coat formed by decomposition of the electrolytic solution and the like. That is, in calculating the oxygen content in the anode active material, oxygen in the foregoing coat is not included in the calculation.

The anode active material containing oxygen may be formed by continuously introducing oxygen gas into a chamber when the anode active material is formed by vapor-phase deposition method. In particular, when a desired oxygen content is not obtained only by introducing the oxygen gas, a liquid (for example, moisture vapor or the like) may be introduced into the chamber as a supply source of oxygen.

Further, the anode active material may contain at least one metal element selected from the group consisting of iron, cobalt, nickel, chromium, titanium, and molybdenum as an element. Thereby, the binding characteristics of the anode active material are improved, expansion and shrinkage of the anode active material layer 2 are inhibited, and resistance of the anode active material is lowered. The metal element content in the anode active material may be voluntarily set. However, in the case where the anode is used for a battery, an excessively high content of the metal element is not practical, since in such a case, the thickness of the anode active material layer 2 should be increased to obtain a desired battery capacity, and thereby separation of the anode active material layer 2 from the anode current collector 1 and break of the anode active material layer 2 may be easily caused.

The anode active material containing the foregoing metal element may be formed by, for example, using an evaporation source mixed with the metal element or using multiple evaporation sources in forming the anode active material by evaporation method as vapor-phase deposition method.

It is preferable that the anode active material has an oxygen-containing region in which the anode active material contains oxygen in the thickness direction, and the oxygen content in the oxygen-containing region is larger than the oxygen content in the other regions. Thereby, expansion and shrinkage of the anode active material layer 2 are inhibited. It is possible that the regions other than the oxygen-containing region contain oxygen or do not contain oxygen. It is needless to say that when the regions other than the oxygen-containing region also contain oxygen, the oxygen content thereof is lower than the oxygen content in the oxygen-containing region.

In this case, to further inhibit expansion and shrinkage of the anode active material layer 2, it is preferable that the regions other than the oxygen-containing region also contain oxygen, and the anode active material includes a first oxygen-containing region (region having the lower oxygen content) and a second oxygen-containing region having the higher oxygen content than that of the first oxygen-containing region (region having the higher oxygen content). In this case, it is preferable that the second oxygen-containing region is sandwiched between the first oxygen-containing regions. It is preferable to the first oxygen-containing region and the second oxygen-containing region are alternately and repeatedly layered. Thereby, higher effects are obtained. The oxygen content in the first oxygen-containing region is preferably small as much as possible. The oxygen content in the second oxygen-containing region is, for example, similar to the oxygen content in the case that the anode active material contains oxygen described above.

The anode active material including the first oxygen-containing region and the second oxygen-containing region may be formed, for example, by intermittently introducing oxygen gas into a chamber or changing the oxygen gas amount introduced into the chamber in forming the anode active material by vapor-phase deposition method. It is needless to say that when a desired oxygen content is not able to be obtained only by introducing the oxygen gas, liquid (for example, moisture vapor or the like) may be introduced into the chamber.

It is possible that the oxygen content of the first oxygen-containing region is clearly different from the oxygen content of the second oxygen-containing region, or the oxygen content of the first oxygen-containing region is not clearly different from the oxygen content of the second oxygen-containing region. In particular, in the case where the introduction amount of the foregoing oxygen gas is continuously changed, the oxygen content may be continuously changed. In the case where the introduction amount of the oxygen gas is intermittently changed, the first oxygen-containing region and the second oxygen-containing region become so-called “layers.” Meanwhile, in the case where the introduction amount of the oxygen gas is continuously changed, the first oxygen-containing region and the second oxygen-containing region become “lamellar state” rather than “layers.” In the latter case, the oxygen content in the anode active material is distributed while the oxygen content changed up and down repeatedly. In this case, it is preferable that the oxygen content is gradually or continuously changed between the first oxygen-containing region and the second oxygen-containing region. When the oxygen content is changed drastically, the ion diffusion characteristics may be lowered, or the resistance may be increased.

In particular, the anode active material layer 2 preferably contains a metal not being alloyed with the electrode reactant together with the anode active material. Since each anode active material is bound to each other through the metal, expansion and shrinkage of the anode active material layer 2 are inhibited. In this case, in particular, even when the anode active material particle is formed by vapor-phase deposition method or the like, high binding characteristics are obtained. Examples of the metal include, for example, a metal containing at least one metal element selected from the group consisting of iron, cobalt, nickel, zinc, and copper. “The metal” in the invention is a comprehensive term, and thus the metal may be one of a simple substance, an alloy, and a compound, as long as the metal contains a metal element not being alloyed with the electrode reactant.

The coat 3 contains a fluorine resin having an ether bond (hereinafter simply referred to as “fluorine resin”). The fluorine resin having an ether bond forms the coat 3 having superior chemical stability. As described above, “fluorine resin having an ether bond” is a generic term used to refer to a polymer compound that has a structure including the main chain composed of a straight carbon chain (with/without the side chain), has the ether bond in such a structure, and has a fluorine group as a substitute group in such a structure. In this case, the ether bond may be located in the main chain, in the side chain, or in both the main chain and the side chain. The fluorine group may be located in the main chain, in the side chain, or in both the main chain and the side chain. It is needless to say that in the case where the main chain has both the ether bond and the fluorine bond, it is possible that no side chain exists.

As the fluorine resin, for example, at least one selected from the group consisting of polymer compounds shown in Chemical formula 1 to Chemical formula 6 are cited, since the coat 3 having sufficient chemical stability is thereby formed. The polymer compounds shown in Chemical formula 1 to Chemical formula 4 are so-called perfluoropolyether, and have an ether bond in the main chain and a fluorine group in the main chain or both in the main chain and the side chain. The perfluoropolyether is a generic term used to refer to a resin having a structure in which the ether bond is linked to a divalent carbon fluoride group (for example, —CF₂—, >CF—CF₃ or the like). The number of ether bonds, the number of carbon fluoride groups, the binding order and the like may be voluntarily set. The polymer compound shown in Chemical formula 5 has an ether bond in the main chain and a fluorine group in the side chain. The polymer compound shown in Chemical formula 6 has an ether bond in the side chain and a fluorine group in the main chain and the side chain. A terminal of the compounds shown in Chemical formula 1 to Chemical formula 6 may be voluntarily set, but is preferably a monovalent carbon fluoride group (for example, —CF₃ or the like). Specially, as the fluorine resin, perfluoropolyether is preferable, since the coat 3 having more superior chemical stability is thereby formed. It is needless to say that the fluorine resin may be a polymer compound other than the compounds shown in Chemical formula 1 to Chemical formula 6, as long as such a compound has an ether bond and a fluorine group. The structure of the fluorine resin (polymer compound type) may be identified by, for example, examining element bonding state in the coat 3 with the use of XPS.

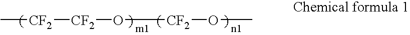

where m1 and n1 are one of integer numbers 1 or higher.

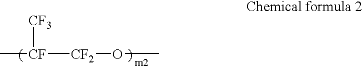

where m2 is one of integer numbers 1 or higher.

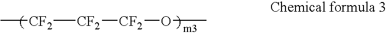

where m3 is one of integer numbers 1 or higher.

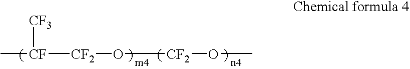

where m4 and n4 are one of integer numbers 1 or higher.

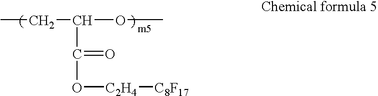

where m5 is one of integer numbers 1 or higher.

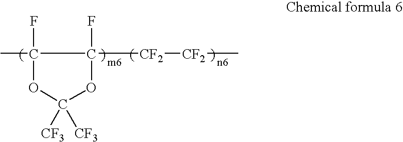

where m6 and n6 are one of integer numbers 1 or higher.

The coat 3 can be formed by, for example, coating method, spray method, dip coating method or the like. However, the coat 3 may be formed by other method.

In particular, in the case where the coat 3 containing the fluorine resin having an ether bond is provided on the anode active material layer 2, the surface of the coat 3 preferably has a fluoride particle of the electrode reactant (hereinafter simply referred to as “fluoride particle”). The fluoride particle functions to inhibit expansion and shrinkage of the anode active material layer 2 and keep the surface area of the anode active material small. Thus, the chemical stability of the anode is more improved. The fluoride particle generated on the surface of the coat 3 is formed by reaction between the electrode reactant and fluorine in the fluorine resin in electrode reaction (for example, in charge and discharge in a battery). For example, in the case where the anode is used for a battery and the electrode reactant contains lithium, the fluoride particle includes lithium fluoride.

The number of fluoride particles may be voluntarily set. In particular, in the case of the particulate anode active material, the number of fluoride particles per 1 particle of the anode active material is preferably in the range from 4 to 500. In this case, the foregoing function of the fluoride particle is remarkably exerted, and thereby higher effects are obtained. More specifically, if the number of fluoride particles is less than 4, there is a possibility that the foregoing function is not sufficiently exerted. Meanwhile, if the number of fluoride particles is more than 500, there is a possibility that the resistance is excessively increased. The number of fluoride particles may be adjusted, for example, as follows. When the coat 3 is formed by spraying a solution containing the fluorine resin onto the surface of the anode active material layer 2 with the use of spray method, the spray amount is changed. When respective generation tendencies of the fluoride particle of the foregoing fluorine resins of Chemical formula 1 to Chemical formula 6 are compared to each other, there is a tendency that the fluoride particle is easily generated in Chemical formula 1 to Chemical formula 4 and Chemical formula 6 having a fluorine group in the main chain. Meanwhile, there is a tendency that the fluoride particle is hardly generated in Chemical formula 5 not having a fluorine group in the main chain.

In the case where the fluoride particle is formed on the surface of the coat 3, formation of the fluoride particle is completed (the number of fluoride particles is determined) in one electrode reaction (first electrode reaction), and no fluoride particle is newly formed (the number of fluoride particles is not increased) through subsequent electrode reactions (on and after the second electrode reaction). Accordingly, if the fluoride particle is generated on the surface of the coat 3, it is possible to determine whether or not the number of fluoride particles is in the foregoing range irrespective of the history of the anode (the number of electrode reactions repeated in the anode until then). Conversely, when the fluoride particle is generated on the surface of the coat 3, it means that an electrode reaction has been already generated in the anode. The foregoing “one electrode reaction” means, in the case of charge and discharge when the anode is used for a battery, a case that the battery is charged and discharged in a general (practical) conditions, but does not mean a case that the battery is charged and discharged under special conditions such as overcharge.

In the case of the particulate anode active material, the coat 3 is preferably an oil film having a cross-linked structure between adjacent particles, since thereby higher effects are obtained. Respective tendencies that the coat 3 becomes the oil film are compared among the foregoing fluorine resins of Chemical formula 1 to Chemical formula 6, the fluorine resin of Chemical formula 6 tends to easily become the oil film.

A detailed structural example of the anode will be herein described. In the following description, a case in which the anode active material is particulate and has a multilayer structure in the particle thereof will be taken as an example.

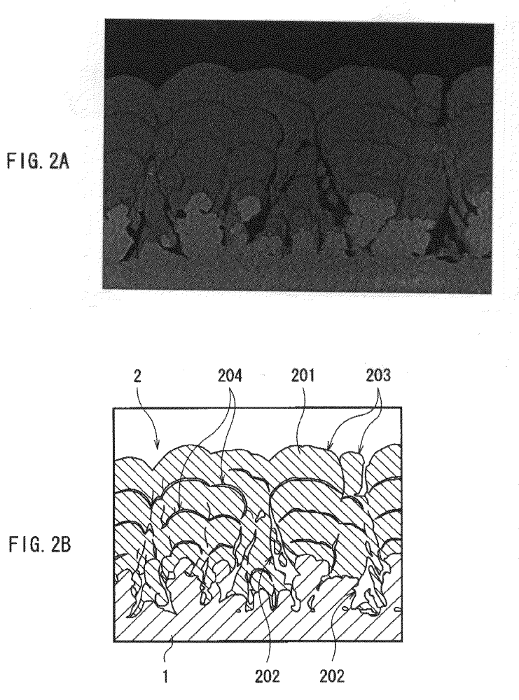

FIGS. 2A and 2B show an enlarged cross sectional structure of the anode current collector 1 and the anode active material layer 2. FIG. 2A is a scanning electron microscope (SEM) photograph (secondary electron image), and FIG. 2B is a schematic drawing of the SEM image shown in FIG. 2A.

As shown in FIGS. 2A and 2B, in the case where the anode active material is composed of a plurality of particles (anode active material particle 201), the anode active material has a plurality of gaps and voids. More specifically, on the roughened surface of the anode current collector 1, a plurality of projections (for example, fine particles formed by electrolytic treatment) exist. In this case, the anode active material is deposited several times on the surface of the anode current collector 1 by vapor-phase deposition method or the like to form a lamination, and thereby the anode active material particle 201 is gradually grown in the thickness direction for every projection mentioned above. According to the density structure, the multilayer structure, and the surface structure of the plurality of anode active material particles 201, a plurality of gaps 202 and 204 and a plurality of voids 203 are generated.

The gap 202 is generated between each anode active material particle 201 as the anode active material particle 201 is grown for every projection existing on the surface of the anode current collector 1. As fibrous minute projections (not shown) are generated on the surface of the anode active material particle 201, the void 203 is generated between the projections. The void 203 may be generated over the entire surface of the anode active material particle 201, or may be generated in part thereof. The gap 204 is generated between each layer as the anode active material particle 201 has a multilayer structure. The foregoing fibrous minute projection is generated on the surface of the anode active material particle 201 every time when the anode active material particle 201 is formed. Thus, the void 203 is generated not only on the uppermost surface (exposed face) of the anode active material particle 201, but also between each layer.

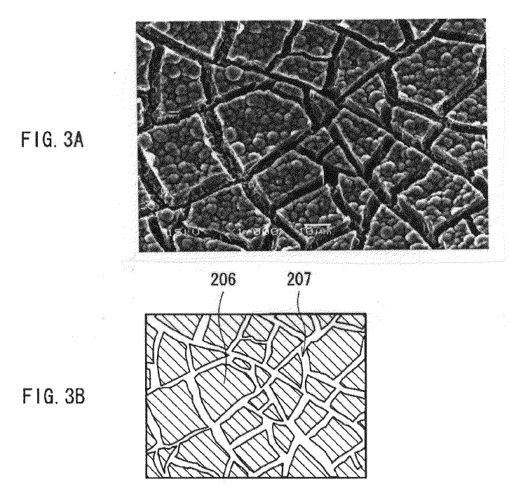

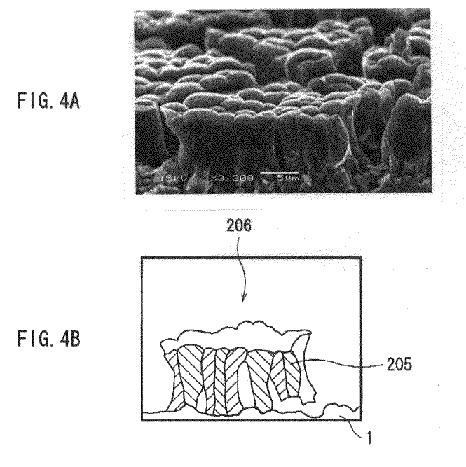

FIGS. 3A and 3B show a particle structure of the surface of the anode active material layer 2. FIG. 3A is an SEM photograph, and FIG. 3B is a schematic drawing of the SEM image shown in FIG. 3A. FIGS. 4A and 4B show a cross section of the anode active material layer 2 shown in FIGS. 3A and 3B. FIG. 4A is an SEM photograph, and FIG. 4B is a schematic drawing of the SEM image shown in FIG. 4A. FIGS. 3A, 3B, 4A, and 4B show a case that the anode active material has a single layer structure.

The plurality of anode active material particles 201 shown in FIGS. 2A and 2B form an aggregate for every given number thereof. That is, in FIG. 3A, the hatched section in FIG. 3B is the aggregate (secondary particle 206) of the anode active material particles 201, and a particle therein is the anode active material particle 201 (primary particle 205). In FIG. 4A, the hatched section in FIG. 4B is the primary particle 205.

As shown in FIGS. 3A to 4B, the secondary particle 206 is separated in the in-plane direction of the anode active material layer 2 by a groove 27 having a depth in the thickness direction of the anode active material layer 2. Further, each primary particle 205 is not simply adjacent to each other, but at least part thereof is bonded to each other to form the secondary particle 206, and the groove 207 almost reaches the anode current collector 1. The groove 207 is formed by electrode reaction (charge and discharge when the anode is used for a battery). The groove 207 is not formed along the primary particle 205 but is relatively linearly generated.

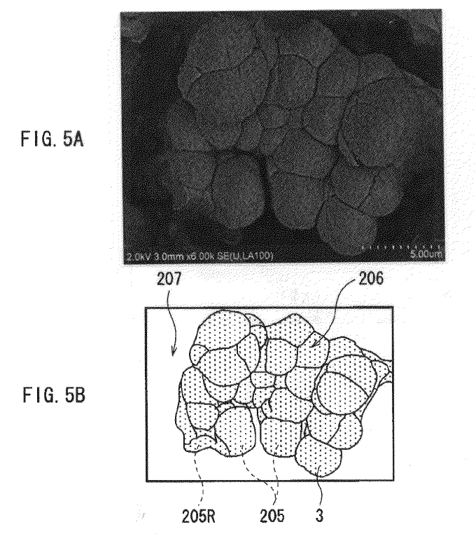

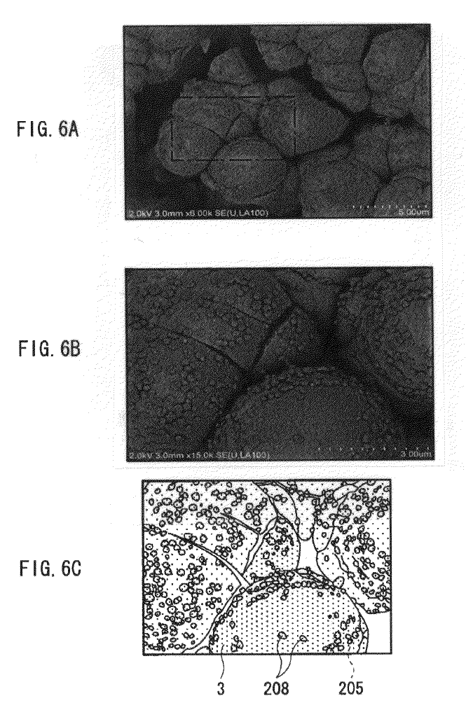

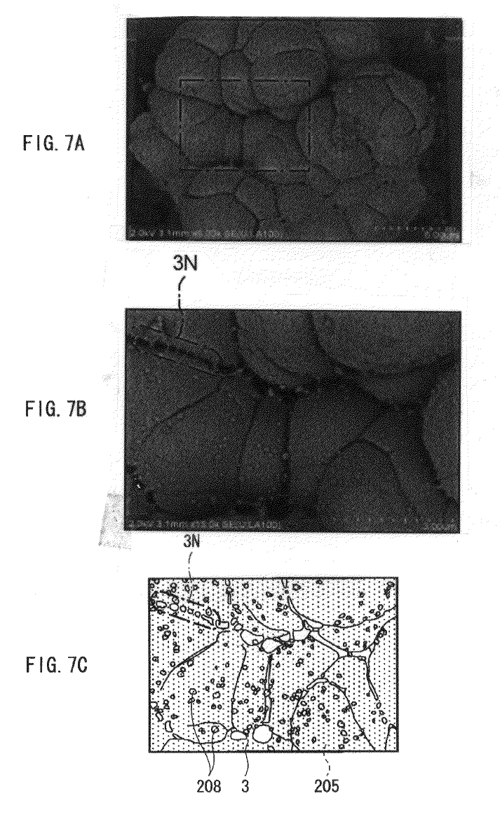

FIGS. 6A and 5B show an enlarged particle structure of the surface of the anode active material layer 2. FIG. 6A is an SEM photograph, and FIG. 5B is a schematic drawing of the SEM image shown in FIG. 6A. FIGS. 6A to 7C show another enlarged particle structure of the surface of the anode active material layer 2. FIGS. 6A and 7A are SEM photographs, FIGS. 6B and 7B are enlarged photographs of part of the respective SEM images shown in FIGS. 6A and 7A (part surrounded by the dashed-dotted line), and FIGS. 6C and 7C are schematic drawings of the respective SEM images shown in FIGS. 6B and 7B.

As shown in FIGS. 6A and 5B, the secondary particle 206 is an aggregate composed of the plurality of primary particles 205 having an approximately circular outline. The coat 3 covers the surface of the secondary particle 206. In this case, part of the primary particle 205 is fractured by the groove 207 to become a fracture particle 205R having an irregular outline out of the circular shape.

In this case, as shown in FIGS. 6A to 6C, the surface of the coat 3 preferably has a fluoride particle 208 through electrode reaction. As described above, the fluoride particle 208 functions to fill in the void 203 shown in FIGS. 2A and 2B to keep the surface area of the anode active material small. In addition, the fluoride particle 208 functions to inhibit expansion and shrinkage of the anode active material layer 2. FIGS. 6A to 6C show a case that the coat 3 is formed by using the fluorine resin shown in Chemical formula 1.

Further, as shown in FIGS. 7A to 7C, the coat 3 is preferably an oil film having a cross-linked structure 3N between adjacent primary particles 205. The “cross-linked structure 3N” is a structure in which each coat 3 is partly linked to each other in a thread state between the primary particles 205 as shown in the part surrounded by the dashed-dotted line in FIGS. 7B and 7C. FIGS. 7A to 7C show a case that the coat 3 is formed by using the fluorine resin shown in Chemical formula 6.

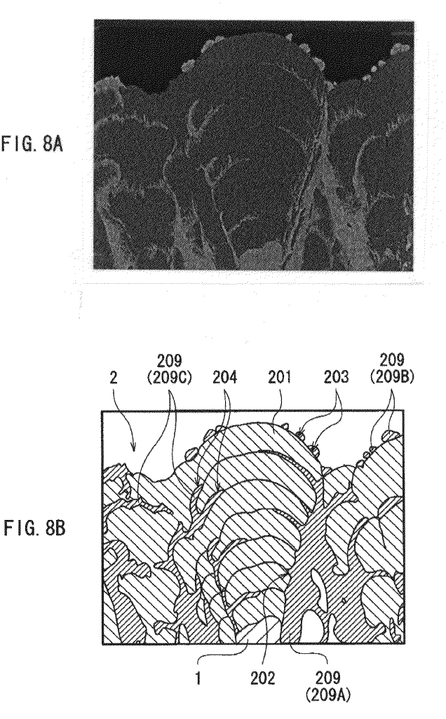

FIGS. 8A and 8B show another cross sectional structure of the anode current collector 1 and the anode active material layer 2, and show a cross section corresponding to part of the anode shown in FIGS. 2A and 2B. As shown in FIGS. 8A and 8B, the anode active material layer 2 preferably has a metal 209 not being alloyed with an electrode reactant in the gaps 202 and 204 and a void 203 shown in FIGS. 2A and 2B. In this case, the metal 209 includes, for example, a metal 209A provided in the gap 202 between adjacent anode active material particles 201, a metal 209B provided in the void 203 existing on the exposed face of the anode active material particle 201, and a metal 209C provided in the gap 204 in the anode active material particle 201. The metal 209 including the metals 209A and 209C has a structure in which the metal 209A functions as a column and the plurality of metals 209C are branched out from the column.

The metal 209A intrudes into the gap 202 between adjacent anode active material particles 201 to improve the binding characteristics of the anode active material layer 2. More specifically, in the case where the anode active material particle 201 is formed by vapor-phase deposition method or the like, as described above, the anode active material particles 201 are grown for every projection existing on the surface of the anode current collector 1, and thus the gap 202 is generated between the anode active material particles 201. The gap 202 causes lowering of the binding characteristics of the anode active material layer 2. Therefore, to improve the binding characteristics, the metal 202A fills the foregoing gap 202. In this case, it is enough that part of the gap 202 is filled therewith, but the larger filling amount is preferable, since thereby the binding characteristics of the anode active material layer 2 are further improved. The filling amount of the metal 202A is preferably 20% or more, more preferably 40% or more, and much more preferably 80% or more.

To prevent a fibrous minute projection (not shown) generated on the exposed face of the uppermost layer of the anode active material particle 201 from adversely affecting the performance of the electrochemical device, the metal 209B covers such a projection. More specifically, in the case where the anode active material particle 201 is formed by vapor-phase deposition method or the like, the fibrous minute projections are generated on the surface thereof, and thus the void 203 is generated between the projections. The void 203 causes increase of the surface area of the anode active material, and accordingly the amount of an irreversible coat formed on the surface is also increased, possibly resulting in lowering of progression of the electrode reaction. Therefore, to avoid the lowering of progression of the electrode reaction, the foregoing void 203 is filled with the metal 209B. In this case, it is enough at minimum that part of the void 203 is filled therewith, but the larger filling amount is preferable, since thereby the lowering of progression of the electrode reaction is further inhibited. In FIGS. 8A and 8B, the metal 209B is dotted on the surface of the uppermost layer of the anode active material particle 201, which means that the foregoing minute projection exists in the location where the metal 209B is dotted. It is needless to say that the metal 209B is not necessarily dotted on the surface of the anode active material particle 201, but may cover the entire surface thereof.

The metal 209C intrudes into the gap 204 in the anode active material particle 201 to improve the biding characteristics of the anode active material layer 2. More specifically, in the case where the anode active material particle 201 has a multilayer structure, the gap 204 is generated between each layer. The gap 204 may cause lowering of the biding characteristics of the anode active material layer 2 as well as the foregoing gap 202 between adjacent anode active material particles 201 may do. Therefore, to improve the biding characteristics, the foregoing gap 204 is filled with the metal 209C. In this case, it is enough at minimum that part of the gap is filled therewith, but the larger filling amount is preferable, since thereby the binding characteristics of the anode active material layer 2 are further improved.

In particular, the metal 209C has a function similar to that of the metal 209B. More specifically, in the case where the anode active material particle 201 is deposited several times and thereby layered, the foregoing minute projection is generated on the surface of the anode active material particle 201 for every deposition. Therefore, the metal 209C fills in not only the gap 104 in the anode active material particle 201, but also the foregoing minute void 203.

The metal 209 is formed by, for example, at least one selected from the group consisting of vapor-phase deposition method and liquid-phase deposition method. Specially, the metal 209 is preferably formed by liquid-phase deposition method. Thereby, the metal 209 easily intrudes into the gaps 202 and 204 and the void 203.

Examples of the foregoing vapor-phase deposition method include a method similar to that used in forming the anode active material. Examples of the liquid-phase deposition method include plating method such as electrolytic plating method and electroless plating method. Specially, as the liquid-phase deposition method, electrolytic plating method is preferable to electroless plating method. Thereby, the metal 209 more easily intrudes into the gaps 202 and 204 and the void 203.

The ratio (molar ratio) M2/M1 of the number of moles M2 per unit area of the metal 209 in relation to the number of moles M1 per unit area of the anode active material particle 201 is preferably in the range from 1/15 to 7/1. Thereby, expansion and shrinkage of the anode active material layer 2 are further inhibited.

The anode is formed, for example, by the following procedure.

First, the anode current collector 1 made of an electrolytic copper foil or the like is prepared. After that, the anode active material is deposited on the anode current collector 1 by using vapor-phase deposition method or the like to form the anode active material layer 2. In the case where the anode active material is deposited by using vapor-phase deposition method, it is possible to form a single layer structure by one deposition step, or a multilayer structure by a plurality of deposition steps. In particular, in the case where the anode active material is formed into the multilayer structure, it is possible that the anode active material is deposited a plurality of times while the anode current collector 1 is relatively moved back and forth an evaporation source, or it is possible that the anode active material is deposited a plurality of times while a shutter is repeatedly opened and closed keeping the anode current collector 1 fixed to the evaporation source. Finally, a fluorine resin having an ether bond is dissolved in a solvent or the like, which is sprayed together with various gas onto the surface of the anode active material layer 2 by spray method or the like to form the coat 3. Thereby, the anode is fabricated.

According to the anode, the coat 3 provided on the anode active material layer 2 contains the fluorine resin having an ether bond. Thus, compared to a case that the coat 3 is not provided or a case that the coat 3 is provided but a fluorine resin does not have an ether bond, the chemical stability of the anode is improved. Such an action is particularly significant when the anode active material contains highly active silicon or tin. In the result, the anode distributes to improve the cycle characteristics of an electrochemical device using the anode.

In particular, when the surface of the coat 3 has the fluoride particle 208 or the coat 3 is an oil film having the cross-linked structure 3N between adjacent anode active material particles 201, the chemical stability of the anode is further improved, and thus higher effects are obtained. In this case, if the number of the fluoride particles 208 per 1 particle of the anode active material particle 201 is in the range from 4 to 500, higher effects are obtained.

Further, when the anode active material contains oxygen and the oxygen content in the anode active material is in the range from 3 atomic % to 40 atomic %, or when the anode active material contains at least one metal element selected from the group consisting of iron, cobalt, nickel, titanium, chromium, and molybdenum, or when the anode active material particle has the oxygen-containing region (region in which oxygen exists and the oxygen content thereof is higher than that of the other regions) in the thickness direction, higher effects are obtained.

Further, when the surface of the anode current collector 1 opposed to the anode active material layer 2 is roughened by the fine particle formed by electrolytic treatment, the contact characteristics between the anode current collector 1 and the anode active material layer 2 are improved. In this case, when the ten points average height of roughness profile Rz of the surface of the anode current collector 1 is in the range from 1.5 μm to 6.5 μm, higher effects are obtained.

In addition, when the anode active material layer 2 has the metal 209 not being alloyed with the electrode reactant in the gaps 202 and 204 and the void 203, the binding characteristics of the anode active material is improved and expansion and shrinkage of the anode active material layer 2 are inhibited, and thus higher effects are obtained. In this case, when the molar ratio M2/M1 between the anode active material particle 201 and the metal is in the range from 1/15 to 7/1, higher effects are obtained. Further, when the metal 209 is formed by liquid-phase deposition method, the metal 209 easily intrudes into the gaps 202 and 204 and the void 203, and thus higher effects are obtained.

Next, a description will be hereinafter given of a usage example of the foregoing anode. As an example of the electrochemical devices, batteries are herein taken. The anode is used for the batteries as follows.

### First Battery

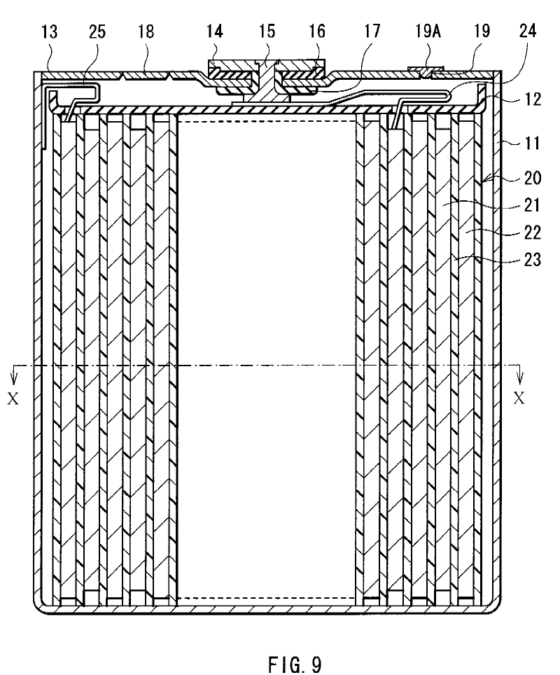

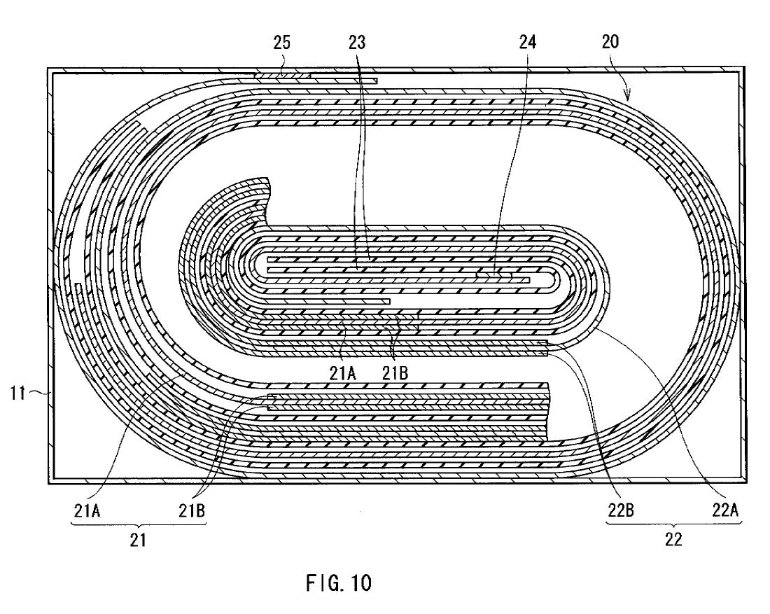

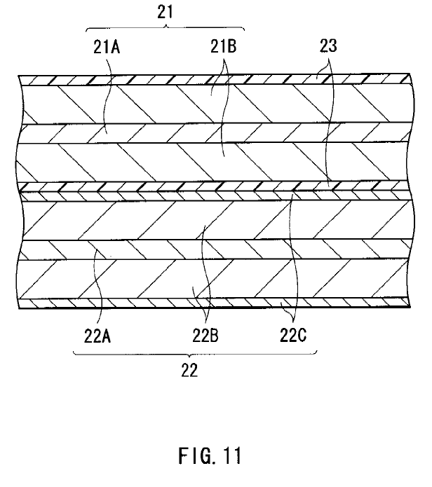

FIG. 9 to FIG. 11 show cross sectional structures of a first battery. FIG. 10 shows a cross section taken along line X-X shown in FIG. 9. FIG. 11 shows an enlarged cross section of part of a battery element 20 shown in FIG. 10. The battery herein described is, for example, a lithium ion secondary battery in which the capacity of an anode 22 is expressed based on insertion and extraction of lithium as an electrode reactant.

In the secondary battery, the battery element 20 having a flat spirally wound structure is contained in a battery can 11.

The battery can 11 is, for example, a square package member. As shown in FIG. 10, the square package member has a shape with the cross section in the longitudinal direction of a rectangle or an approximate rectangle (including curved lines in part). The square package member structures not only a square battery in the shape of a rectangle, but also a square battery in the shape of an oval. That is, the square package member means a rectangle vessel-like member with the bottom or an oval vessel-like member with the bottom, which respectively has an opening in the shape of a rectangle or in the shape of an approximate rectangle (oval shape) formed by connecting circular arcs by straight lines. FIG. 10 shows a case that the battery can 11 has a rectangular cross sectional shape. The battery structure including the battery can 11 is called square structure.

The battery can 11 is made of, for example, a metal material containing iron, aluminum (Al), or an alloy thereof. The battery can 11 may have a function as an electrode terminal as well. As the metal material, to inhibit the secondary battery from being swollen by using the rigidity (hardly deformable characteristics) of the battery can 11 when charged and discharged, rigid iron is preferable to aluminum. In this case, the iron may be plated by nickel (Ni) or the like.

The battery can 11 also has a hollow structure in which one end of the battery can 11 is closed and the other end thereof is opened. At the open end of the battery can 11, an insulating plate 12 and a battery cover 13 are attached, and thereby inside of the battery can 11 is hermetically closed. The insulating plate 12 is located between the battery element 20 and the battery cover 13, is arranged perpendicularly to the spirally wound circumferential face of the battery element 20, and is made of, for example, polypropylene or the like. The battery cover 13 is, for example, made of a material similar to that of the battery can 11, and also has a function as an electrode terminal as the battery can 11 does.

Outside of the battery cover 13, a terminal plate 14 as a cathode terminal is arranged. The terminal plate 14 is electrically insulated from the battery cover 13 with an insulating case 16 in between. The insulating case 16 is made of, for example, polybutylene terephthalate or the like. In the approximate center of the battery cover 13, a through-hole is provided. A cathode pin 15 is inserted in the through-hole so that the cathode pin is electrically connected to the terminal plate 14 and is electrically insulated from the battery cover 13 with a gasket 17 in between. The gasket 17 is made of, for example, an insulating material, and the surface thereof is coated with asphalt.

In the vicinity of the rim of the battery cover 13, a cleavage valve 18 and an injection hole 19 are provided. The cleavage valve 18 is electrically connected to the battery cover 13. If the internal pressure of the battery becomes a certain level or more by internal short circuit, external heating or the like, the cleavage valve 18 is separated from the battery cover 13 to release the internal pressure. The injection hole 19 is sealed by a sealing member 19A made of, for example, a stainless steel ball.

The battery element 20 is formed by layering a cathode 21 and the anode 22 with a separator 23 in between and then spirally winding the resultant laminated body. The battery element 20 is flat according to the shape of the battery can 11. A cathode lead 24 made of aluminum or the like is attached to an end of the cathode 21 (for example, the internal end thereof). An anode lead 25 made of nickel or the like is attached to an end of the anode 22 (for example, the outer end thereof). The cathode lead 24 is electrically connected to the terminal plate 14 by being welded to an end of the cathode pin 15. The anode lead 25 is welded and electrically connected to the battery can 11.

In the cathode 21, for example, a cathode active material layer 21B is provided on the both faces of a strip-shaped cathode current collector 21A. The cathode current collector 21A is made of, for example, a metal material such as aluminum, nickel, and stainless. The cathode active material layer 21B contains a cathode active material, and if necessary, may also contain a binder, a conductive material and the like.

The cathode active material contains one or more cathode materials capable of inserting and extracting lithium as an electrode reactant. As the cathode material, for example, a lithium complex oxide such as lithium cobalt oxide, lithium nickel oxide, a solid solution containing them (Li(NiₓCo_{y}Mn_{z})O₂, values of x, y, and z are respectively expressed as 0<x<1, 0<y<1, 0<z<1, and x+y+z=1), lithium manganese oxide having a spinel structure (LiMn₂O₄), and a solid solution thereof (Li(Mn₂₋ᵥNiᵥ)O₄, a value of v is expressed as v<2) can be cited. Further, as the cathode material, for example, a phosphate compound having an olivine structure such as lithium iron phosphate (LiFePO₄) is cited. Thereby, a high energy density is obtained. In addition, as the cathode material, for example, an oxide such as titanium oxide, vanadium oxide, and manganese dioxide; a disulfide such as iron disulfide, titanium disulfide, and molybdenum sulfide; sulfur; a conductive polymer such as polyaniline and polythiophene are cited.

As shown in FIG. 11, the anode 22 has a structure similar to that of the anode described above. For example, in the anode 22, an anode active material layer 22B and a coat 22C are provided in this order on the both faces of a strip-shaped anode current collector 22A. The structures of the anode current collector 22A, the anode active material layer 22B, and the coat 22C are respectively similar to the structures of the anode current collector 1, the anode active material layer 2, and the coat 3 in the anode described above.

The separator 23 separates the cathode 21 from the anode 22, and passes ions as an electrode reactant while preventing current short circuit due to contact of the both electrodes. The separator 23 is made of, for example, a porous film made of a synthetic resin such as polytetrafluoroethylene, polypropylene, and polyethylene, or a ceramic porous film. The separator 23 may have a structure in which two or more porous films as the foregoing porous films are layered.

An electrolytic solution as a liquid electrolyte is impregnated in the separator 23. The electrolytic solution contains, for example, a solvent and an electrolyte salt dissolved therein.

The solvent contains, for example, one or more nonaqueous solvents such as an organic solvent. The nonaqueous solvents include, for example, an ester carbonate solvent such as ethylene carbonate, propylene carbonate, butylene carbonate, dimethyl carbonate, diethyl carbonate, ethyl methyl carbonate, and methylpropyl carbonate. Thereby, superior capacity characteristics, superior storage characteristics, and superior cycle characteristics are obtained. One thereof may be used singly, or two or more thereof may be used by mixture. Specially, as the solvent, a mixture of a high viscosity solvent such as ethylene carbonate and propylene carbonate and a low viscosity solvent such as dimethyl carbonate, ethyl methyl carbonate, and diethyl carbonate is preferable. Thereby, the dissociation property of the electrolyte salt and the ion mobility are improved, and thus higher effects are obtained.

The solvent preferably contains halogenated ester carbonate, since thereby a stable coat is formed on the surface of the anode 22, and thus the decomposition reaction of the electrolytic solution is inhibited and the cycle characteristics are improved. As the halogenated ester carbonate, fluorinated ester carbonate is preferable, and difluoroethylene carbonate is preferable, since thereby higher effects are obtained. As difluoroethylene carbonate, for example, 4,5-difluoro-1,3-dioxolane-2-one or the like is cited.

Further, the solvent preferably contains a cyclic ester carbonate having an unsaturated bond, since thereby the cycle characteristics are improved. As the cyclic ester carbonate having an unsaturated bond, for example, vinylene carbonate, vinyl ethylene carbonate and the like are cited.

Further, the solvent preferably contains sultone, since thereby the cycle characteristics are improved, and the secondary battery is inhibited from being swollen. As the sultone, for example, 1,3-propene sultone or the like is cited.

The electrolyte salt contains, for example, one or more light metal salts such as a lithium salt. As the lithium salt, for example, lithium hexafluorophosphate (LiPF₆), lithium perchlorate (LiClO₄), lithium hexafluoroarsenate (LiAsF₆) or the like is cited. Thereby, superior capacity characteristics, superior storage characteristics, and superior cycle characteristics are obtained. One thereof may be used singly, or two or more thereof may be used by mixture. Specially, as the electrolyte salt, lithium hexafluorophosphate is preferable, since the internal resistance is lowered, and thus higher effects are obtained.

Further, the electrolyte salt preferably contains a compound having boron and fluorine, since the cycle characteristics are thereby improved and swollenness of the secondary battery is thereby inhibited. As the compound having boron and fluorine, for example, lithium tetrafluoroborate or the like is cited.

The content of the electrolyte salt in the solvent is preferably in the range from 0.3 mol/kg to 3.0 mol/kg, since thereby superior capacity characteristics are obtained.

The secondary battery is manufactured, for example, by the following procedure.

First, the cathode 21 is formed. First, a cathode active material, a binder, and an electrical conductor are mixed to prepare a cathode mixture, which is dispersed in an organic solvent to form paste cathode mixture slurry. Subsequently, the both faces of the cathode current collector 21A are uniformly coated with the cathode mixture slurry by using a doctor blade, a bar coater or the like, which is dried. Finally, the resultant is compression-molded by a rolling press machine or the like while being heated if necessary to form the cathode active material layer 21B. In this case, the resultant may be compression molded several times.

Next, the anode 22 is formed by forming the anode active material layer 22B and the coat 22C on the both faces of the anode current collector 22A by the same procedure as that of forming the anode described above.

Next, the battery element 20 is formed by using the cathode 21 and the anode 22. First, the cathode lead 24 and the anode lead 25 are respectively attached to the cathode current collector 21A and the anode current collector 22A by welding or the like. Subsequently, the cathode 21 and the anode 22 are layered with the separator 23 in between, and spirally wound in the longitudinal direction. Finally, the resultant is formed in the flat shape, and thereby the battery element 20 is formed.

The secondary battery using the foregoing components is assembled as follows. First, after the battery element 20 is contained in the battery can 11, the insulating plate 12 is arranged on the battery element 20. Subsequently, the cathode lead 24 and the anode lead 25 are respectively connected to the cathode pin 15 and the battery can 11 by welding or the like. After that, the battery cover 13 is fixed on the open end of the battery can 11 by laser welding or the like. Finally, the electrolytic solution is injected into the battery can 11 from the injection hole 19, and impregnated in the separator 23. After that, the injection hole 19 is sealed by the sealing member 19A. The secondary battery shown in FIG. 9 to FIG. 11 is thereby fabricated.

In the secondary battery, when charged, for example, lithium ions are extracted from the cathode 21, and are inserted in the anode 22 through the electrolytic solution impregnated in the separator 23. Meanwhile, when discharged, for example, lithium ions are extracted from the anode 22, and are inserted in the cathode 21 through the electrolytic solution impregnated in the separator 23.

According to the square secondary battery, since the anode 22 has the structure similar to that of the foregoing anode, the discharge capacity is hardly lowered even when charge and discharge are repeated. Accordingly, the cycle characteristics are improved. In this case, even when the anode 22 contains silicon advantageous for obtaining a high capacity, the cycle characteristics are improved. Thus, higher effects are thereby obtained compared to a case in which the anode contains other anode material such as a carbon material.

In particular, the package member is composed of the battery can 11 made of the rigid metal. Thus, compared to a case that the battery can is made of a soft film, the anode 22 is hardly damaged when the anode active material layer 22B is expanded and shrunk. Therefore, the cycle characteristics are further improved. In this case, when the battery can 11 is made of iron more rigid than aluminum, higher effects are obtained.

Effects of the secondary battery other than the foregoing effects are similar to those of the foregoing anode.

### Second Battery

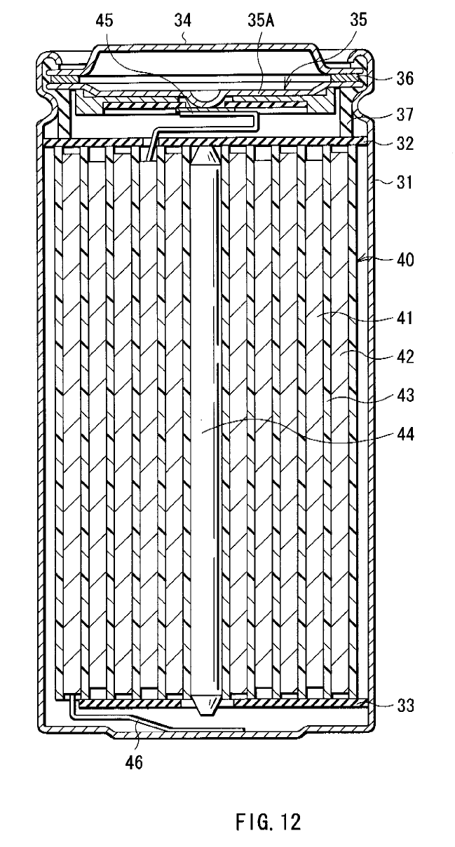

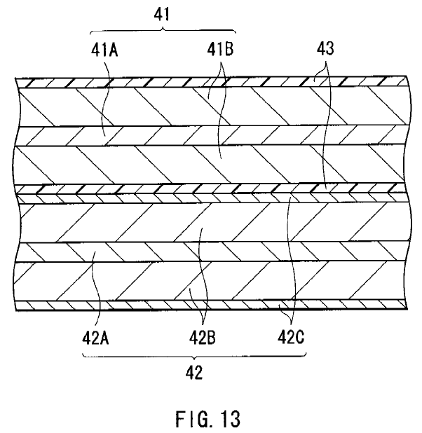

FIG. 12 and FIG. 13 show a cross sectional structure of a second battery. FIG. 13 shows an enlarged part of a spirally wound electrode body 40 shown in FIG. 12. The battery is a lithium ion secondary battery as the foregoing first battery. The second battery contains the spirally wound electrode body 40 in which a cathode 41 and an anode 42 are spirally wound with a separator 43 in between, and a pair of insulating plates 32 and 33 inside a battery can 31 in the shape of an approximately hollow cylinder. The battery structure including the battery can 31 is a so-called cylindrical secondary battery.

The battery can 31 is made of, for example, a metal material similar to that of the battery can 11 in the foregoing first battery. One end of the battery can 31 is closed, and the other end thereof is opened. The pair of insulating plates 32 and 33 is arranged to sandwich the spirally wound electrode body 40 therebetween and to extend perpendicularly to the spirally wound periphery face.

At the open end of the battery can 31, a battery cover 34, and a safety valve mechanism 35 and a PTC (Positive Temperature Coefficient) device 36 provided inside the battery cover 34 are attached by being caulked with a gasket 37. Inside of the battery can 31 is thereby hermetically sealed. The battery cover 34 is made of, for example, a material similar to that of the battery can 31. The safety valve mechanism 35 is electrically connected to the battery cover 34 through the PTC device 36. In the safety valve mechanism 35, if the internal pressure becomes a certain level or more by internal short circuit, external heating or the like, a disk plate 35A flips to cut the electric connection between the battery cover 34 and the spirally wound electrode body 40. When temperature rises, the PTC device 36 increases the resistance and thereby limits a current to prevent abnormal heat generation resulting from a large current. The gasket 37 is made of, for example, an insulating material and its surface is coated with asphalt.

For example, a center pin 44 may be inserted in the center of the spirally wound electrode body 40. In the spirally wound electrode body 40, a cathode lead 45 made of aluminum or the like is connected to the cathode 41, and an anode lead 46 made of nickel or the like is connected to the anode 42. The cathode lead 45 is electrically connected to the battery cover 34 by being welded to the safety valve mechanism 35. The anode lead 46 is welded and thereby electrically connected to the battery can 31.

The cathode 41 has a structure in which, for example, a cathode active material layer 41B is provided on the both faces of a strip-shaped cathode current collector 41A. The anode 42 has, for example, a structure in which an anode active material layer 42B and the coat 42C are provided in this order on the both faces of a strip-shaped anode current collector 42A. The structures of the cathode current collector 41A, the cathode active material layer 41B, the anode current collector 42A, the anode active material layer 42B, the coat 42C, and the separator 43 and the composition of the electrolytic solution are respectively similar to the structures of the cathode current collector 21A, the cathode active material layer 21B, the anode current collector 22A, the anode active material layer 22B, the coat 22C, and the separator 23 and the composition of the electrolytic solution in the foregoing first battery.

The secondary battery is manufactured, for example, as follows.

First, for example, the cathode 41 in which the cathode active material layer 41B is provided on the both faces of the cathode current collector 41A is formed and the anode 42 in which the anode active material layer 42B and the coat 42C are provided on the both faces of the anode current collector 42A is formed by respective procedures similar to the procedures of forming the cathode 21 and the anode 22 in the foregoing first battery. Subsequently, the cathode lead 45 is attached to the cathode 41, and the anode lead 46 is attached to the anode 42. Subsequently, the cathode 41 and the anode 42 are spirally wound with the separator 43 in between, and thereby the spirally wound electrode body 40 is formed. The end of the cathode lead 45 is welded to the safety valve mechanism 35, and the end of the anode lead 46 is welded to the battery can 31. After that, the spirally wound electrode body 40 is sandwiched between the pair of insulating plates 32 and 33, and contained in the battery can 31. Subsequently, the electrolytic solution is injected into the battery can 31 and impregnated in the separator 43. Finally, at the open end of the battery can 31, the battery cover 34, the safety valve mechanism 35, and the PTC device 36 are fixed by being caulked with the gasket 37. The secondary battery shown in FIG. 12 and FIG. 13 is thereby fabricated.

In the secondary battery, when charged, for example, lithium ions are extracted from the cathode 41 and inserted in the anode 42 through the electrolytic solution. Meanwhile, when discharged, for example, lithium ions are extracted from the anode 42, and inserted in the cathode 41 through the electrolytic solution.

According to the cylindrical secondary battery, the anode 42 has the structure similar to that of the foregoing anode. Thus, the cycle characteristics are improved. Effects of the secondary battery other than the foregoing effects are similar to those of the first battery.

### Third Battery

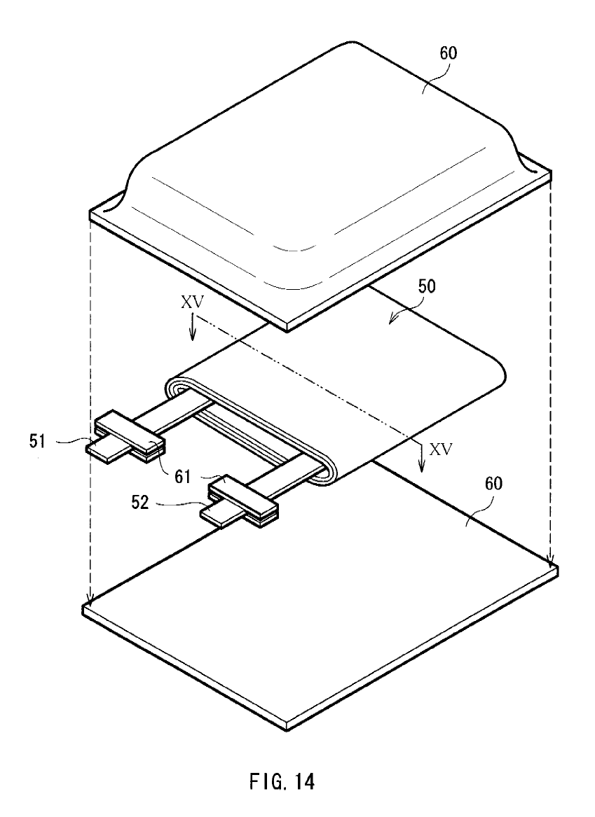

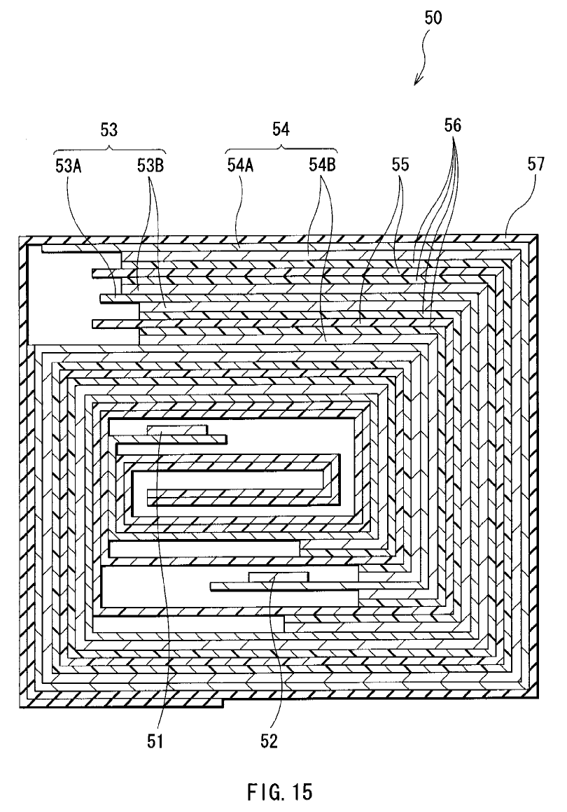

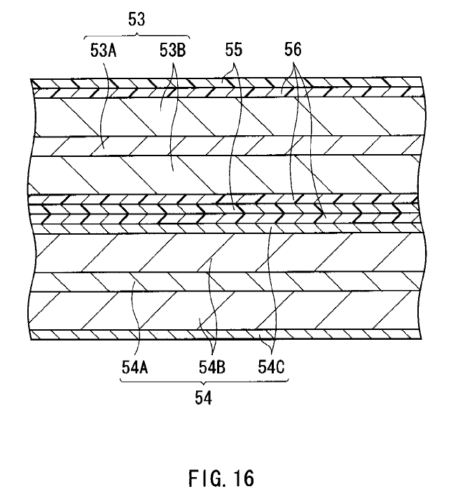

FIG. 14 to FIG. 16 show a structure of a third battery. FIG. 14 shows an exploded perspective structure, FIG. 15 shows an exploded cross section taken along line XV-XV shown in FIG. 14, and FIG. 16 shows an exploded cross section of part of a spirally wound electrode body 50 shown in FIG. 15. In the battery, the spirally wound electrode body 50 on which a cathode lead 51 and an anode lead 52 are attached is contained in a film package member 60. The battery structure including the package member 60 is a so-called laminated film structure.

The cathode lead 51 and the anode lead 52 are respectively directed from inside to outside of the package member 60 in the same direction, for example. The cathode lead 51 is made of, for example, a metal material such as aluminum, and the anode lead 52 is made of, for example, a metal material such as copper, nickel, and stainless. The cathode lead 51 and the anode lead 52 are in the shape of a thin plate or mesh.

The package member 60 is made of an aluminum laminated film in which, for example, a nylon film, an aluminum foil, and a polyethylene film are bonded together in this order. The package member 60 has, for example, a structure in which the respective outer edges of two pieces of rectangle aluminum laminated films are bonded to each other by fusion bonding or an adhesive so that the polyethylene film and the spirally wound electrode body 50 are opposed to each other.

An adhesive film 61 to protect from entering of outside air is inserted between the package member 60 and the cathode lead 51, the anode lead 52. The adhesive film 61 is made of a material having contact characteristics to the cathode lead 51 and the anode lead 52. Examples of such a material include, for example, a polyolefin resin such as polyethylene, polypropylene, modified polyethylene, and modified polypropylene.

The package member 60 may be made of a laminated film having other lamination structure, a polymer film such as polypropylene, or a metal film, instead of the foregoing aluminum laminated film.

In the spirally wound electrode body 50, a cathode 53 and an anode 54 are layered with a separator 55 and an electrolyte 56 in between and then spirally wound. The outermost periphery thereof is protected by a protective tape 57.

The cathode 53 has a structure in which, for example, a cathode active material layer 53B is provided on the both faces of a cathode current collector 53A having a pair of opposed faces. The anode 54, for example, has a structure in which an anode active material layer 54B and a coat 54C are provided in this order on the both faces of a strip-shaped anode current collector 54A. The structures of the cathode current collector 53A, the cathode active material layer 53B, the anode current collector 54A, the anode active material layer 54B, the coat 54C, and the separator 55 are respectively similar to those of the cathode current collector 21A, the cathode active material layer 21B, the anode current collector 22A, the anode active material layer 22B, the coat 22C, and the separator 23 of the foregoing first battery.

The electrolyte 56 is a so-called gel electrolyte, containing an electrolytic solution and a polymer compound that holds the electrolytic solution. The gel electrolyte is preferable, since thereby high ion conductivity (for example, 1 mS/cm or more at room temperature) is obtained and liquid leakage is prevented. The electrolyte 56 is provided, for example, between the cathode 53 and the separator 55, and between the anode 54 and the separator 55.

As the polymer compound, for example, polyacrylonitrile, polyvinylidene fluoride, a copolymer of polyvinylidene fluoride and polyhexafluoropropylene, polytetrafluoroethylene, polyhexafluoro propylene, polyethylene oxide, polypropylene oxide, polyphosphazene, polysiloxane, polyvinyl acetate, polyvinyl alcohol, polymethacrylic acid methyl, polyacrylic acid, polymethacrylic acid, styrene-butadiene rubber, nitrile-butadiene rubber, polystyrene, polycarbonate or the like is cited. One of these polymer compounds may be used singly, or two or more thereof may be used by mixture. Specially, polyacrylonitrile, polyvinylidene fluoride, polyhexafluoropropylene, polyethylene oxide or the like is preferably used, since thereby the electrochemical stability is obtained.

The composition of the electrolytic solution is similar to the composition of the electrolytic solution in the first battery. However, in this case, the solvent means a wide concept including not only the liquid solvent but also a solvent having ion conductivity capable of dissociating the electrolyte salt. Therefore, in the case where the polymer compound having ion conductivity is used, the polymer compound is also included in the solvent.

Instead of the gel electrolyte 56 in which the electrolytic solution is held by the polymer compound, the electrolytic solution may be directly used. In this case, the electrolytic solution is impregnated in the separator 55.

The secondary battery including the gel electrolyte 56 is manufactured, for example, as follows.

First, the cathode 53 in which the cathode active material layer 53B is provided on the both faces of the cathode current collector 53A is formed and the anode 54 in which the anode active material layer 54B and the coat 54C are provided on the both faces of the anode current collector 54A is formed by respective procedures similar to the foregoing procedures of forming the cathode 21 and the anode 22 in the foregoing first battery. Subsequently, a precursor solution containing an electrolytic solution, a polymer compound, and a solvent is prepared. Then, the cathode 53 and the anode 54 are respectively coated with the precursor solution. After that, the solvent is volatilized to form the gel electrolyte 56. Subsequently, the cathode lead 51 is attached to the cathode current collector 53A, and the anode lead 52 is attached to the anode current collector 54A. Subsequently, the cathode 53 and the anode 54 formed with the electrolyte 56 are layered with the separator 55 in between to obtain a laminated body. After that, the laminated body is spirally wound in the longitudinal direction, the protective tape 57 is adhered to the outermost periphery thereof to form the spirally wound electrode body 50. Subsequently, for example, the spirally wound electrode body 50 is sandwiched between the package members 60, and outer edges of the package members 60 are contacted by thermal fusion bonding or the like to enclose the spirally wound electrode body 50. Then, the adhesive film 61 is inserted between the cathode lead 51/the anode lead 52 and the package member 60. Thereby, the secondary battery shown in FIG. 14 to FIG. 16 is fabricated.

Otherwise, the foregoing secondary battery may be manufactured as follows. First, the cathode lead 51 and the anode lead 52 are respectively attached on the cathode 53 and the anode 54. After that, the cathode 53 and the anode 54 are layered with the separator 55 in between and spirally wound. The protective tape 57 is adhered to the outermost periphery thereof, and a spirally wound body as a precursor of the spirally wound electrode body 50 is formed. Subsequently, the spirally wound body is sandwiched between the package members 60, the peripheral edges other than one side of the peripheral edges are contacted by thermal fusion-bonding or the like to obtain a pouched state, and the spirally wound body is contained in the pouched-like package member 60. Subsequently, a composition of matter for electrolyte containing the electrolytic solution, a monomer as a raw material for a polymer compound, a polymerization initiator, and if necessary other material such as a polymerization inhibitor is prepared, which is injected into the pouched-like package member 60. After that, the opening of the package member 60 is hermetically sealed by, for example, thermal fusion bonding or the like. Finally, the monomer is thermally polymerized to obtain a polymer compound. Thereby, the gel electrolyte 56 is formed. Consequently, the secondary battery shown in FIG. 14 to FIG. 16 is fabricated.

According to the laminated film secondary battery, the anode 54 has the structure similar to that of the foregoing anode. Thus, the cycle characteristics are improved. Effects of the secondary battery other than the foregoing effects are similar to those of the first battery.

### EXAMPLES

Examples of the invention will be described in detail.

### Example 1-1

The laminated film secondary battery shown in FIG. 14 to FIG. 16 was manufactured by the following procedure. The secondary battery was manufactured as a lithium ion secondary battery in which the capacity of the anode 54 was expressed based on insertion and extraction of lithium.

First, the cathode 53 was formed. First, lithium carbonate (Li₂CO₃) and cobalt carbonate (CoCO₃) were mixed at a molar ratio of 0.5:1. After that, the mixture was fired in the air at 900 deg C. for 5 hours. Thereby, lithium cobalt complex oxide (LiCoO₂) was obtained. Subsequently, 91 parts by weight of the lithium cobalt complex oxide as a cathode active material, 6 parts by weight of graphite as an electrical conductor, and 3 parts by weight of polyvinylidene fluoride as a binder were mixed to obtain a cathode mixture. After that, the cathode mixture was dispersed in N-methyl-2-pyrrolidone to obtain a paste cathode mixture slurry. Finally, the both faces of the cathode current collector 53A made of a strip-shaped aluminum foil (thickness: 12 μm thick) were uniformly coated with the cathode mixture slurry, which was dried. After that, the resultant was compression-molded by a roll pressing machine to form the cathode active material layer 53B.

Next, the anode 54 was formed. First, the anode current collector 54A made of an electrolytic copper foil (thickness: 18 μm thick, ten points average height roughness profile Rz: 3.5 μm) was prepared. After that, silicon was deposited on the both faces of the anode current collector 54A by electron beam evaporation method using a deflective electron beam evaporation source so that a plurality of anode active particles had a single layer structure (thickness: 7.5 μm). Thereby, the anode active material layer 54B was formed. When the anode active material layer 54B was formed, silicon with the purity of 99% was used as the evaporation source, and the deposition rate was 10 nm/sec. Further, oxygen gas and if necessary moisture vapor were continuously introduced into the chamber so that the oxygen content in the anode active material particle was 3 atomic %. Subsequently, the fluorine resin shown in Chemical formula 1 was dissolved in a solvent containing hexafluoro xylene and pentafluoro butane, which was sprayed together with carbon dioxide gas onto the anode active material layer 54B by spray method to form the coat 54C. In forming the coat 54C, the spray amount (weight of the fluorine resin per unit area) was 0.0006 mg/cm².

Next, the cathode lead 51 made of aluminum was attached to one end of the cathode current collector 53A by welding, and the anode lead 52 made of nickel was attached to one end of the anode current collector 54A by welding. Subsequently, the cathode 53, the three-layer polymer separator 55 (thickness: 23 μm) in which a porous polyethylene film was sandwiched between porous polypropylene films, the anode 54, and the foregoing polymer separator 55 were layered in this order. The resultant laminated body was spirally wound in the longitudinal direction, the end of the spirally wound body was fixed by the protective tape 57 made of an adhesive tape, and thereby a spirally wound body as a precursor of the spirally wound electrode body 50 was formed. Subsequently, the spirally wound body was sandwiched between the package members 60 made of a three-layer laminated film (total thickness: 100 μm) in which nylon (thickness: 30 μm), aluminum (thickness: 40 μm), and cast polypropylene (thickness: 30 μm) were layered from the outside. After that, outer edges other than an edge of one side of the package members were thermally fusion-bonded to each other. Thereby, the spirally wound body was contained in the package members 60 in a pouched state. Subsequently, an electrolytic solution was injected through the opening of the package member 60, the electrolytic solution was impregnated in the separator 55, and thereby the spirally wound electrode body 50 was formed.

When the electrolytic solution was prepared, a mixed solvent of ethylene carbonate (EC) and diethyl carbonate (DEC) as a solvent was used, and lithium hexafluorophosphate (LiPF₆) was used as an electrolyte salt. The composition of the mixed solvent (EC:DEC) was 50:50 at a weight ratio. The concentration of the electrolyte salt was 1 mol/kg.

Finally, the opening of the package member 60 was thermally fusion bonded and sealed in the vacuum atmosphere. After that, to stabilize the battery state, 1 cycle of charge and discharge was preformed. The charge condition was as follows. That is, after charge was performed at the constant current density of 3 mA/cm² until the battery voltage reached 4.2 V, charge was continuously performed at the constant voltage of 4.2 V until the battery density reached 0.3 mA/cm². The discharge conditions were as follows. That is, discharge was performed at the constant current density of 3 mA/cm² until the battery voltage reached 2.5 V. Thereby, the laminated film secondary battery was fabricated.

When the secondary battery was manufactured, while the secondary battery for examining the cycle characteristics was manufactured, the secondary battery for examining the number of fluoride particles was manufactured. After the both secondary batteries were manufactured, the latter secondary battery was decomposed to take out the anode 54, and then the surface of the anode 54 was observed by SEM. In the result, lithium fluoride was generated as the fluoride particle on the surface of the coat 54C, and the number of the fluoride particles per 1 particle of the anode active material particle was 2.

### Examples 1-2 to 1-12

A procedure was performed in the same manner as that of Example 1-1, except that the spray amount and the number of fluoride particles were respectively 0.001 mg/cm² and 4 (Example 1-2), 0.003 mg/cm² and 10 (Example 1-3), 0.007 mg/cm² and 25 (Example 1-4), 0.014 mg/cm² and 50 (Example 1-6), 0.029 mg/cm² and 100 (Example 1-6), 0.057 mg/cm² and 200 (Example 1-7), 0.086 mg/cm² and 300 (Example 1-8), 0.115 mg/cm² and 400 (Example 1-9), 0.143 mg/cm² and 500 (Example 1-10), 0.172 mg/cm² and 600 (Example 1-11), 0.2 mg/cm² and 700 (Example 1-12) instead of 0.0006 mg/cm² and 2.

### Comparative Example 1

A procedure was performed in the same manner as that of Example 1-1, except that the coat 54C was not formed.

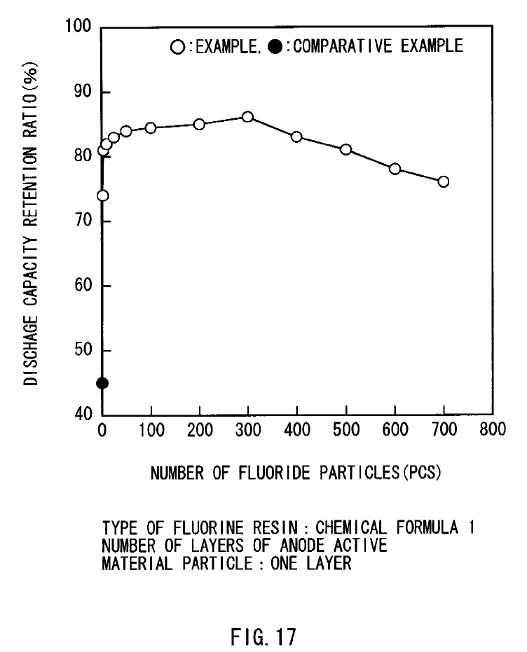

When the cycle characteristics of the secondary batteries of Examples 1-1 to 1-12 and Comparative example 1 were examined, the results shown in Table 1 and FIG. 17 were obtained.

In examining the cycle characteristics, a cycle test was performed by the following procedure, and thereby the discharge capacity retention ratio was obtained. First, charge and discharge were performed in the atmosphere at 23 deg C. and the discharge capacity at the first cycle was measured. Subsequently, the secondary battery was charged and discharged 99 cycles in the same atmosphere, and thereby the discharge capacity at the 100th cycle was measured. Finally, the discharge capacity retention ratio (%)=(discharge capacity at the 100th cycle/discharge capacity at the first cycle)×100 was calculated. The charge and discharge condition was similar to that in the case of manufacturing the secondary battery.

The procedure and the conditions for examining the number of fluoride particles and the discharge capacity retention ratio were similarly applied to the following examples and comparative examples.

TABLE 1
Anode active material: silicon (electron beam evaporation method)
Ten points average height of roughness profile Rz: 3.5 μm
Oxygen content in the anode active material: 3 atomic %

| | Anode active material | | | | |
|---|---|---|---|---|---|
| | layer | Coat | | | Discharge |
| | Number of layers of | | | Number of | capacity |
| | anode active material | | | fluoride | retention |
| | particle | Type of fluorine | Spray amount | particles | ratio |
| | (layer) | resin | (mg/cm²) | (pcs) | (%) |
| Example 1-1 | 1 | Chemical | 0.0006 | 2 | 74 |
| Example 1-2 | | formula 1 | 0.001 | 4 | 81 |
| Example 1-3 | | | 0.003 | 10 | 82 |
| Example 1-4 | | | 0.007 | 25 | 83 |
| Example 1-5 | | | 0.014 | 50 | 84 |
| Example 1-6 | | | 0.029 | 100 | 84.5 |
| Example 1-7 | | | 0.057 | 200 | 85 |
| Example 1-8 | | | 0.086 | 300 | 86.1 |
| Example 1-9 | | | 0.115 | 400 | 83 |
| Example | | | 0.143 | 500 | 81 |
| 1-10 | | | | | |
| Example | | | 0.172 | 600 | 78 |
| 1-11 | | | | | |
| Example | | | 0.2 | 700 | 76 |
| 1-12 | | | | | |
| Comparative | 1 | — | — | — | 45 |
| example 1 | | | | | |

As shown in Table 1 and FIG. 17, when the anode active material layer 54B containing the anode active material particles having the single-layer structure and composed of silicon was formed by electron beam evaporation method, in Examples 1-1 to 1-12 in which the coat 54C containing the fluorine resin shown in Chemical formula 1 was formed, the discharge capacity retention ratio was largely higher than that of Comparative example 1 in which the coat 54C was not formed. The result showed that when the coat 54C was provided on the anode active material layer 54B, the electrolytic solution was hardly decomposed and thus the discharge capacity was hardly lowered even if charge and discharge were repeated. In this case, as the number of fluoride particles was increased, the discharge capacity retention ratio tended to become higher. When the number of fluoride particles was less than 4 or more than 500, the discharge capacity retention ratio was lower than 80%. Accordingly, it was confirmed that in the secondary battery of the invention, the cycle characteristics were improved when the coat containing the fluorine resin shown in Chemical formula 1 was provided on the anode active material layer. In this case, it was also confirmed that when the number of fluoride particles per 1 particle of the anode active material particles was in the range from 4 to 500, higher effects were obtained.

### Examples 2-1 to 2-10

A procedure was performed in the same manner as that of Examples 1-1, 1-2, and 1-4 to 1-11, except that the anode active material particle was formed into six-layer structure (total thickness: 7.5 μm). In this case, silicon was sequentially deposited while the anode current collector 54A was moved back and forth to an evaporation source at the deposition rate of 100 nm/sec.

### Comparative Example 2

A procedure was performed in the same manner as that of Comparative example 1, except that the anode active material particle was formed into six-layer structure as in Examples 2-1 to 2-10.

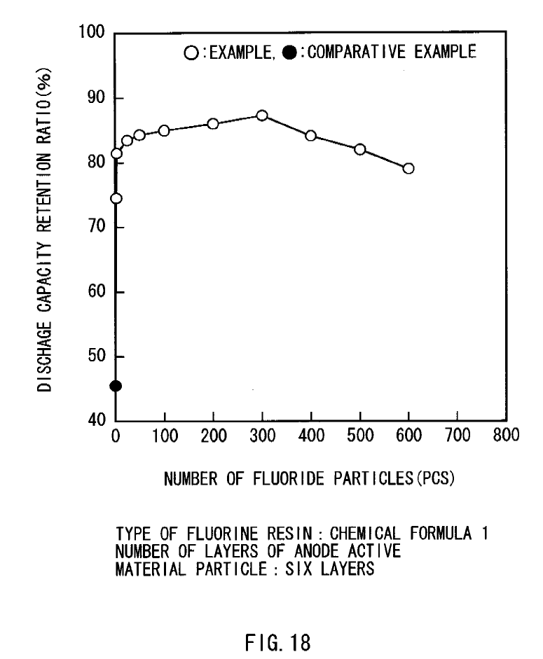

When the cycle characteristics of the secondary batteries of Examples 2-1 to 2-10 and Comparative example 2 were examined, the results shown in Table 2 and FIG. 18 were obtained.

TABLE 2
Anode active material: silicon (electron beam evaporation method)
Ten points average height of roughness profile Rz: 3.5 μm
Oxygen content in the anode active material: 3 atomic %

| | Anode active material | | | | |
|---|---|---|---|---|---|
| | layer | Coat | | | Discharge |
| | Number of layers of | | | Number of | capacity |
| | anode active material | | | fluoride | retention |
| | particle | Type of fluorine | Spray amount | particles | ratio |
| | (layer) | resin | (mg/cm²) | (pcs) | (%) |
| Example 2-1 | 6 | Chemical | 0.0006 | 2 | 74.5 |
| Example 2-2 | | formula 1 | 0.001 | 4 | 81.5 |
| Example 2-3 | | | 0.007 | 25 | 83.5 |
| Example 2-4 | | | 0.014 | 50 | 84.3 |
| Example 2-5 | | | 0.029 | 100 | 85 |
| Example 2-6 | | | 0.057 | 200 | 86 |
| Example 2-7 | | | 0.086 | 300 | 87.3 |
| Example 2-8 | | | 0.115 | 400 | 84.1 |
| Example 2-9 | | | 0.143 | 500 | 82 |
| Example | | | 0.172 | 600 | 79 |
| 2-10 | | | | | |
| Comparative | 6 | — | — | — | 45.5 |
| example 2 | | | | | |

As shown in Table 2 and FIG. 18, in Examples 2-1 to 2-10 in which the anode active material layer 54B containing the anode active material particle having the six-layer structure and composed of silicon was formed by electron beam evaporation method, results similar to those of Examples 1-1 to 1-12 were obtained. That is, in Examples 2-1 to 2-10 in which the coat 54C was formed, the discharge capacity retention ratio was largely higher than that of Comparative example 2 in which the coat 54C was not formed. When the number of fluoride particles was in the range from 4 to 500, the discharge capacity retention ratio of 80% or more was obtained. In this case, as evident by comparison between Examples 1-8 and 2-7 having the number of layers of anode active material particle different from each other, the discharge capacity retention ratio in the case that the number of layers was 6 was higher than that in the case that the number of layers was 1. Accordingly, it was confirmed that in the secondary battery of the invention, the cycle characteristics were also improved when the anode active material particle was formed into six-layer structure in the case that the coat contained the fluorine resin shown in Chemical formula 1. It was also confirmed that when the number of layers was increased, higher effects were obtained.

### Examples 3-1 to 3-3

A procedure was performed in the same manner as that of Examples 1-7 to 1-9, except that the anode active material layer 54B was formed by sintering method. In this case, first, 90 parts by weight of silicon powder as an anode active material (average particle diameter: 6 μm) and 10 parts by weight of polyvinylidene fluoride as a binder were mixed. After that, the mixture was dispersed in N-methyl-2-pyrrolidone to obtain paste anode mixture slurry. Subsequently, the both faces of the anode current collector 54A was uniformly coated with the anode mixture slurry, and then such a resultant coat was extended by applying pressure. Finally, the coat was heated at 220 deg C. for 12 hours in the vacuum atmosphere.

### Comparative Example 3

A procedure was performed in the same manner as that of Comparative example 1, except that the anode active material layer 54B was formed by sintering method as in Examples 3-1 to 3-3.

When the cycle characteristics of the secondary batteries of Examples 3-1 to 3-3 and Comparative example 3 were examined, the results shown in Table 3 were obtained.

TABLE 3
Anode active material: silicon (sintering method)
Ten points average height of roughness profile Rz: 3.5 μm
Oxygen content in the anode active material: 3 atomic %

| | Coat | | | Discharge |
|---|---|---|---|---|
| | | | Number of | capacity |
| | Type of | Spray | fluoride | retention |
| | fluorine | amount | particles | ratio |
| | resin | (mg/cm²) | (pcs) | (%) |
| Example 3-1 | Chemical | 0.057 | 200 | 80 |
| Example 3-2 | formula 1 | 0.086 | 300 | 81 |
| Example 3-3 | | 0.115 | 400 | 80 |
| Comparative | — | — | — | 40 |
| example 3 | | | | |

As shown in Table 3, in Examples 3-1 to 3-3 in which the anode active material layer 54B containing silicon as an anode active material was formed by sintering method, the discharge capacity retention ratio was also largely improved as in Examples 1-1 to 1-12 more than that of Comparative example 3 in which the coat 54C was not formed. Accordingly, it was confirmed that in the secondary battery of the invention, the cycle characteristics were also improved when sintering method was used as a method of forming the anode active material layer.

### Examples 4-1 to 4-3

A procedure was performed in the same manner as that of Examples 1-7 to 1-9, except that the anode active material layer 54B containing a tin-cobalt alloy as an anode active material was formed by coating method. In this case, first, powder tin-cobalt alloy was formed by atomizing method. After that, the resultant tin-cobalt alloy was pulverized until the particle diameter became 15 μm. The atomicity ratio of tin and cobalt was 20:80. Subsequently, 75 parts by weight of the tin-cobalt alloy powder as an anode active material, 20 parts by weight of scale-like graphite as an electrical conductor and an anode active material, 2.5 parts by weight of styrene-butadiene rubber as a binder, and 2.5 parts by weight of carboxymethyl cellulose as a thickener were mixed. After that, the mixture was dispersed in pure water to obtain anode mixture slurry. Finally, the both faces of the anode current collector 54A were uniformly coated with the anode mixture slurry, dried, and then the resultant was compression-molded by a rolling press machine. For the fabricated anode 54, a cross section was exposed by focused ion beam etching (FIB) method, and then local element analysis was performed by auger electron spectrometer (AES). In the result, it was confirmed that the element of the anode current collector 54A and the element of the anode active material layer 54B were diffused into each other at the interface between the anode current collector 54A and the anode active material layer 54B, and the both elements were alloyed.

### Comparative Example 4

A procedure was performed in the same manner as that of Comparative example 1, except that the anode active material layer 54B containing a tin-cobalt alloy as an anode active material was formed by coating method as in Examples 4-1 to 4-3.

When the cycle characteristics of the secondary batteries of Examples 4-1 to 4-3 and Comparative example 4 were examined, the results shown in Table 4 were obtained.

TABLE 4
Anode active material: tin-cobalt alloy (coating method)
Ten points average height of roughness profile Rz: 3.5 μm
Oxygen content in the anode active material: 3 atomic %

| | Coat | | | Discharge |
|---|---|---|---|---|
| | | | Number of | capacity |
| | Type of | Spray | fluoride | retention |
| | fluorine | amount | particles | ratio |
| | resin | (mg/cm²) | (pcs) | (%) |
| Example 4-1 | Chemical | 0.057 | 200 | 80 |
| Example 4-2 | formula 1 | 0.086 | 300 | 83 |
| Example 4-3 | | 0.115 | 400 | 81 |
| Comparative | — | — | — | 50 |
| example 4 | | | | |

As shown in Table 4, in Examples 4-1 to 4-3 in which the anode active material layer 54B containing the tin-cobalt alloy as an anode active material was formed by coating method, the discharge capacity retention ratio was also largely improved as in Examples 1-1 to 1-12 more than that of Comparative example 4 in which the coat 54C was not formed. Accordingly, it was confirmed that in the secondary battery of the invention, the cycle characteristics were also improved when a tin alloy such as the tin-cobalt alloy was used as an anode active material.

### Examples 5-1 to 5-3

A procedure was performed in the same manner as that of Examples 1-7 to 1-9, except that the anode active material layer 54B containing a carbon material as an anode active material was formed by coating method. In this case, first, 87 parts by weight of mesophase carbon microbeads (average particle diameter: 25 μm) as an anode active material, 3 parts by weight of graphite, and 10 parts by weight of polyvinylidene fluoride as a binder were mixed. After that, the mixture was dispersed in N-methyl-2-pyrrolidone to obtain anode mixture slurry. After that, the both faces of the anode current collector 54A were coated with the anode mixture slurry, dried, and then such a resultant was compression-molded by a rolling press machine.

### Comparative Example 5

A procedure was performed in the same manner as that of Comparative example 1, except that the anode active material layer 54B containing a carbon material as an anode active material was formed by coating method as in Examples 5-1 to 5-3.

When the cycle characteristics of the secondary batteries of Examples 5-1 to 5-3 and Comparative example 5 were examined, the results shown in Table 5 were obtained.

TABLE 5
Anode active material: carbon material (coating method)
Ten points average height of roughness profile Rz: 3.5 μm
Oxygen content in the anode active material: 3 atomic %

| | Coat | | | Discharge |
|---|---|---|---|---|
| | | | Number of | capacity |
| | Type of | Spray | fluoride | retention |
| | fluorine | amount | particles | ratio |
| | resin | (mg/cm²) | (pcs) | (%) |
| Example 5-1 | Chemical | 0.057 | 200 | 91 |
| Example 5-2 | formula 1 | 0.086 | 300 | 91 |
| Example 5-3 | | 0.115 | 400 | 90 |
| Comparative | — | — | — | 88 |
| example 5 | | | | |

As shown in Table 5, in Examples 5-1 to 5-3 in which the anode active material layer 54B containing the carbon material as an anode active material was formed by coating method, the discharge capacity retention ratio was also largely improved as in Examples 1-1 to 1-12 more than that of Comparative example 5 in which the coat 54C was not formed. Accordingly, it was confirmed that in the secondary battery of the invention, the cycle characteristics were also improved when the carbon material was used as an anode active material.

From the foregoing results of Table 1 to Table 5, it was confirmed that when the coat containing the fluorine resin having an ether bond is provided on the anode active material layer, the cycle characteristics were improved not depending on the type of the anode active material and the method of forming the anode active material layer. In this case, as evidenced by comparison among Examples 1-8, 2-7, 3-2, 4-2, and 5-2 having the different forming methods of the anode active material layer each other, it was confirmed that in the case that silicon and the tin alloy were used, the increase ratio of the discharge capacity retention ratio (increase ratio of the discharge capacity retention ratio due to providing the coat) was larger than that in the case that the carbon material was used as an anode active material. It may result from the following fact. That is, when the material containing silicon and tin advantageous for obtaining a high capacity was used as an anode active material, the electrolytic solution was easily decomposed than in the case of using the carbon material. Thus, the decomposition inhibition effect of the electrolytic solution by the coat was remarkably exercised. Further, it was confirmed that when silicon was used, the discharge capacity retention ratio in the case of using vapor-phase deposition method (electron beam evaporation method) was higher than that in the case of using sintering method.

### Examples 6-1 to 6-8

A procedure was performed in the same manner as that of Examples 1-1, 1-2, and 1-4, 1-6, 1-8, and 1-10 to 1-12, except that the coat 54C was formed by using the fluorine resin shown in Chemical formula 6, and the spray amount was adjusted to set the number of fluoride particles.

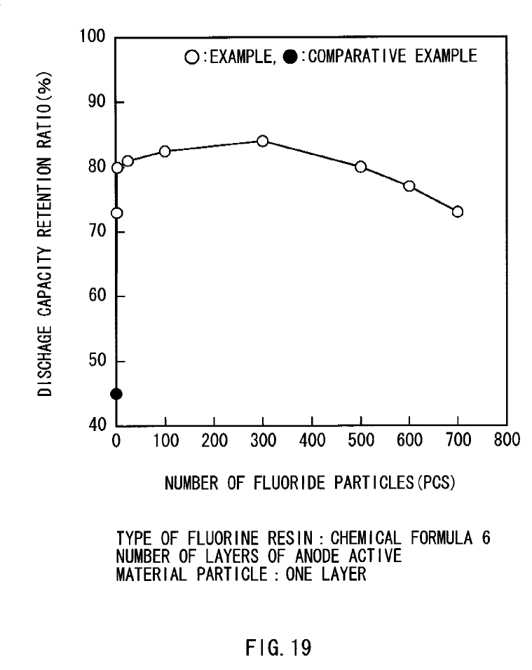

When the cycle characteristics of the secondary batteries of Examples 6-1 to 6-8 were examined, the results shown in Table 6 and FIG. 19 were obtained.

TABLE 6
Anode active material: silicon (electron beam evaporation method)
Ten points average height of roughness profile Rz: 3.5 μm
Oxygen content in the anode active material particle: 3 atomic %

| | Anode active material | | | | |
|---|---|---|---|---|---|
| | layer | Coat | | | Discharge |
| | Number of layers of | | | Number of | capacity |
| | anode active material | | | fluoride | retention |
| | particle | Type of fluorine | Spray amount | particles | ratio |
| | (layer) | resin | (mg/cm²) | (pcs) | (%) |
| Example 6-1 | 1 | Chemical | 0.033 | 2 | 73 |
| Example 6-2 | | formula 6 | 0.085 | 4 | 80 |
| Example 6-3 | | | 0.124 | 25 | 81 |
| Example 6-4 | | | 0.169 | 100 | 82.5 |
| Example 6-5 | | | 0.182 | 300 | 84 |
| Example 6-6 | | | 0.192 | 500 | 80 |
| Example 6-7 | | | 0.201 | 600 | 77 |
| Example 6-8 | | | 2.101 | 700 | 73 |
| Comparative | 1 | — | — | — | 45 |
| example 1 | | | | | |

As shown in Table 6 and FIG. 19, in Examples 6-1 to 6-8 in which the coat 54C was formed by using the fluorine resin shown in Chemical formula 6, results similar to that of Examples 1-1 to 1-12 were also obtained. That is, in Examples 6-1 to 6-8 in which the coat 54C was formed, the discharge capacity retention ratio was largely higher than that of Comparative example 1 in which the coat 54C was not formed. When the number of fluoride particles was in the range from 4 to 500, the discharge capacity retention ratio of 80% or more was obtained. Accordingly, it was confirmed that in the secondary battery of the invention, the cycle characteristics were also improved when the coat containing the fluorine resin shown in Chemical formula 6 was provided on the anode active material layer.

### Examples 7-1 to 7-3

A procedure was performed in the same manner as that of Examples 2-5, 2-7, and 2-9, except that the coat 54C was formed by using the fluorine resin shown in Chemical formula 6 as in Examples 6-1 to 6-8.

When the cycle characteristics of the secondary batteries of Examples 7-1 to 7-3 were examined, the results shown in Table 7 were obtained.

TABLE 7
Anode active material: carbon (coating method)
Ten points average height of roughness profile Rz: 3.5 μm
Oxygen content in the anode active material particle: 3 atomic %

| | Anode active | | | | |
|---|---|---|---|---|---|
| | material layer | Coat | | | Discharge |
| | Number of layers of | | | Number of | capacity |
| | anode active material | | | fluoride | retention |
| | particle | Type of | Spray amount | particles | ratio |
| | (layer) | fluorine resin | (mg/cm²) | (pcs) | (%) |
| Example 7-1 | 6 | Chemical | 0.169 | 100 | 83 |
| Example 7-2 | | formula 6 | 0.182 | 300 | 84.5 |
| Example 7-3 | | | 0.192 | 500 | 81 |
| Comparative | 6 | — | — | — | 45.5 |
| example 2 | | | | | |

As shown in Table 7, in Examples 7-1 to 7-3 in which the anode active material particle was formed into six-layer structure, the discharge capacity retention ratio was largely higher than that of Comparative example 2 in which the coat 54C was not formed. Accordingly, it was confirmed that in the secondary battery of the invention, the cycle characteristics were also improved when the anode active material particle was formed into six-layer structure in the case that the coat containing the fluorine resin shown in Chemical formula 6 was provided.

### Examples 8-1 to 8-4

A procedure was performed in the same manner as that of Examples 2-5 to 2-8, except that the coat 54C was formed by using the fluorine resin shown in Chemical formula 2, and the spray amount was adjusted to set the number of fluoride particles.

When the cycle characteristics of the secondary batteries of Examples 8-1 to 8-4 were examined, the results shown in Table 8 were obtained.

TABLE 8
Anode active material: silicon (electron beam evaporation method)
Ten points average height of roughness profile Rz: 3.5 μm
Oxygen content in the anode active material particle: 3 atomic %

| | Anode active | | | | |
|---|---|---|---|---|---|
| | material layer | Coat | | | Discharge |
| | Number of layers of | | | Number of | capacity |
| | anode active material | | | fluoride | retention |
| | particle | Type of | Spray amount | particles | ratio |
| | (layer) | fluorine resin | (mg/cm²) | (pcs) | (%) |
| Example 8-1 | 6 | Chemical | 0.022 | 100 | 84.5 |
| Example 8-2 | | formula 2 | 0.054 | 200 | 85 |
| Example 8-3 | | | 0.081 | 300 | 86.2 |
| Example 8-4 | | | 0.108 | 400 | 83.5 |
| Comparative | 6 | — | — | — | 45.5 |
| example 2 | | | | | |

As shown in Table 8, in Examples 8-1 to 8-4 in which the coat 54C was formed by using the fluorine resin shown in Chemical formula 2, the discharge capacity retention ratio was largely higher as in Examples 2-1 to 2-10 than that of Comparative example 2 in which the coat 54C was not formed. Accordingly, it was confirmed that in the secondary battery of the invention, the cycle characteristics were also improved when the coat containing the fluorine resin shown in Chemical formula 2 was provided on the anode active material layer.

### Examples 9-1 to 9-4

A procedure was performed in the same manner as that of Examples 2-5 to 2-8, except that the coat 54C was formed by using the fluorine resin shown in Chemical formula 3, and the spray amount was adjusted to set the number of fluoride particles.

When the cycle characteristics of the secondary batteries of Examples 9-1 to 9-4 were examined, the results shown in Table 9 were obtained.

TABLE 9
Anode active material: silicon (electron beam evaporation method)
Ten points average height of roughness profile Rz: 3.5 μm
Oxygen content in the anode active material particle: 3 atomic %

| | Anode active | | | | |
|---|---|---|---|---|---|
| | material layer | Coat | | | Discharge |
| | Number of layers of | | | Number of | capacity |
| | anode active material | | | fluoride | retention |
| | particle | Type of | Spray amount | particles | ratio |
| | (layer) | fluorine resin | (mg/cm²) | (pcs) | (%) |
| Example 9-1 | 6 | Chemical | 0.021 | 100 | 84.1 |
| Example 9-2 | | formula 3 | 0.053 | 200 | 84.6 |
| Example 9-3 | | | 0.08 | 300 | 85.4 |
| Example 9-4 | | | 0.106 | 400 | 82.8 |
| Comparative | 6 | — | — | — | 45.5 |
| example 2 | | | | | |

As shown in Table 9, in Examples 9-1 to 9-4 in which the coat 54C was formed by using the fluorine resin shown in Chemical formula 3, the discharge capacity retention ratio was largely higher as in Examples 2-1 to 2-10 than that of Comparative example 2 in which the coat 54C was not formed. Accordingly, it was confirmed that in the secondary battery of the invention, the cycle characteristics were also improved when the coat containing the fluorine resin shown in Chemical formula 3 was provided on the anode active material layer.

### Examples 10-1 to 10-4

A procedure was performed in the same manner as that of Examples 2-5 to 2-8, except that the coat 54C was formed by using the fluorine resin shown in Chemical formula 4, and the spray amount was adjusted to set the number of fluoride particles.

When the cycle characteristics of the secondary batteries of Examples 10-1 to 10-4 were examined, the results shown in Table 10 were obtained.

TABLE 10
Anode active material: silicon (electron beam evaporation method)
Ten points average height of roughness profile Rz: 3.5 μm
Oxygen content in the anode active material particle: 3 atomic %

| | Anode active | | | | |
|---|---|---|---|---|---|
| | material layer | Coat | | | Discharge |
| | Number of layers of | | | Number of | capacity |
| | anode active material | | | fluoride | retention |
| | particle | Type of | Spray amount | particles | ratio |
| | (layer) | fluorine resin | (mg/cm²) | (pcs) | (%) |
| Example | 6 | Chemical | 0.033 | 100 | 84 |
| 10-1 | | formula 4 | | | |
| Example | | | 0.066 | 200 | 84 |
| 10-2 | | | | | |
| Example | | | 0.098 | 300 | 85.2 |
| 10-3 | | | | | |
| Example | | | 0.133 | 400 | 82.1 |
| 10-4 | | | | | |
| Comparative | 6 | — | — | — | 45.5 |
| example 2 | | | | | |

As shown in Table 10, in Examples 10-1 to 10-4 in which the coat 54C was formed by using the fluorine resin shown in Chemical formula 4, the discharge capacity retention ratio was largely higher as in Examples 2-1 to than that of Comparative example 2 in which the coat 54C was not formed. Accordingly, it was confirmed that in the secondary battery of the invention, the cycle characteristics were also improved when the coat containing the fluorine resin shown in Chemical formula 4 was provided on the anode active material layer.

### Examples 11-1 to 11-4

A procedure was performed in the same manner as that of Examples 2-5 to 2-8, except that the coat 54C was formed by using the fluorine resin shown in Chemical formula 5, and the spray amount was adjusted to set the number of fluoride particles.

When the cycle characteristics of the secondary batteries of Examples 11-1 to 11-4 were examined, the results shown in Table 11 were obtained.

TABLE 11
Anode active material: silicon (electron beam evaporation method)
Ten points average height of roughness profile Rz: 3.5 μm
Oxygen content in the anode active material particle: 3 atomic %

| | Anode active | | | | |
|---|---|---|---|---|---|
| | material layer | Coat | | | Discharge |
| | Number of layers of | | | Number of | capacity |
| | anode active material | | | fluoride | retention |
| | particle | Type of | Spray amount | particles | ratio |
| | (layer) | fluorine resin | (mg/cm²) | (pcs) | (%) |
| Example | 6 | Chemical | 0.077 | 1 to2 | 67.3 |
| 11-1 | | formula 5 | | | |
| Example | | | 0.103 | 1 to 2 | 67.5 |
| 11-2 | | | | | |
| Example | | | 0.211 | 2 to 3 | 68.1 |
| 11-3 | | | | | |
| Example | | | 0.422 | 2 to 3 | 60.5 |
| 11-4 | | | | | |
| Comparative | 6 | — | — | — | 45.5 |
| example 2 | | | | | |

As shown in Table 11, in Examples 11-1 to 11-4 in which the coat 54C was formed by using the fluorine resin shown in Chemical formula 5, the discharge capacity retention ratio was largely higher as in Examples 2-1 to 2-10 than that of Comparative example 2 in which the coat 54C was not formed. Accordingly, it was confirmed that in the secondary battery of the invention, the cycle characteristics were also improved when the coat containing the fluorine resin shown in Chemical formula 5 was provided on the anode active material layer.

### Examples 12-1 to 12-3

A procedure was performed in the same manner as that of Examples 2-7, 6-4, and 11-4, except that the anode active material particle was formed into 12-layer structure, and 4-fluoro-1,3-dioxolane-2-one (FEC) as fluorinated ester carbonate (monofluoroethylene carbonate) was used instead of EC as a solvent.

### Comparative Example 12

A procedure was performed in the same manner as that of Comparative example 1, except that the anode active material was formed into 12-layer structure as in Examples 12-1 to 12-3.

When the cycle characteristics of the secondary batteries of Examples 12-1 to 12-3 and Comparative example 12 were examined, the results shown in Table 12 were obtained.

TABLE 12
Anode active material: silicon (electron beam evaporation method)
Ten points average height of roughness profile Rz: 3.5 μm
Oxygen content in the anode active material particle: 3 atomic %

| | Anode active | | | | |
|---|---|---|---|---|---|
| | material layer | Coat | | | Discharge |
| | Number of layers of | | | Number of | capacity |
| | anode active material | | | fluoride | retention |
| | particle | Type of | Spray amount | particles | ratio |
| | (layer) | fluorine resin | (mg/cm²) | (pcs) | (%) |
| Example | 12 | Chemical | 0.086 | 300 | 91 |
| 12-1 | | formula 1 | | | |
| Example | | Chemical | 0.169 | 100 | 85.5 |
| 12-2 | | formula 6 | | | |
| Example | | Chemical | 0.422 | 2 to 3 | 62.2 |
| 12-3 | | formula 5 | | | |
| Comparative | 12 | — | — | — | 48 |
| example 12 | | | | | |

As shown in Table 12, in Examples 12-1 to 12-3 in which the anode active material particle was formed into 12-layer structure, the discharge capacity retention ratio was largely higher as in Examples 2-1 to 2-10, 6-1 to 6-8, and 11-1 to 11-4 than that of Comparative example 12 in which the coat 54C was not formed. Accordingly, it was confirmed that in the secondary battery of the invention, the cycle characteristics were also improved when the anode active material particle was formed into 12-layer structure.

From the foregoing results of Table 6 to Table 12, it was confirmed that the cycle characteristics were also improved when the coat was formed by using any of the fluorine resins shown in Chemical formula 1 to Chemical formula 6. In this case, as evidenced by comparison among Examples 2-7, 11-1, and 11-2 in which the spray amount was almost identical with each other, it was confirmed that the cycle characteristics were more improved in the case of using the fluorine resins shown in Chemical formula 1 to Chemical formula 4 and Chemical formula 6 than in the case of using the fluorine resin shown in Chemical formula 5, since the number of fluoride particles was larger in the case of using the fluorine resins shown in Chemical formula 1 to Chemical formula 4 and Chemical formula 6 than in the case of using the fluorine resin shown in Chemical formula 5. Further, as evidenced by comparison among Examples 2-7, 6-5, 8-3, 9-3, and 10-3 in which the number of fluoride particles was identical with each other, it was confirmed that the cycle characteristics were more improved in the case of using the fluorine resins shown in Chemical formula 1 to Chemical formula 4 (perfluoropolyether) than in the case of using the fluorine resin shown in Chemical formula 6.

As a representative of the examples and comparative examples described above, when the anodes 54 used for the secondary batteries of Examples 12-1 to 12-3 and Comparative example 12 were analyzed by XPS for the bonding state of elements and the element distribution state before and after charge and discharge. The following results were obtained.

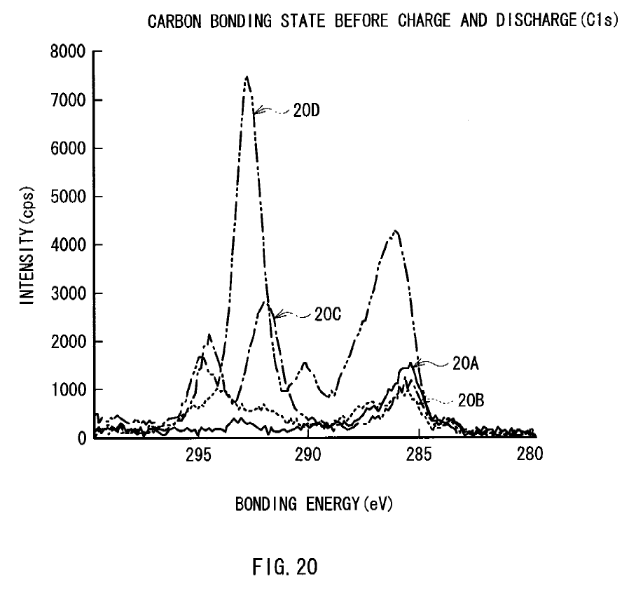

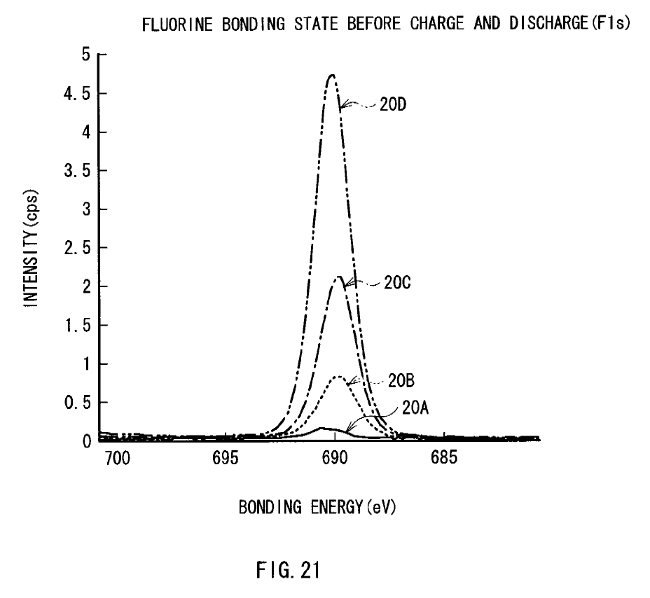

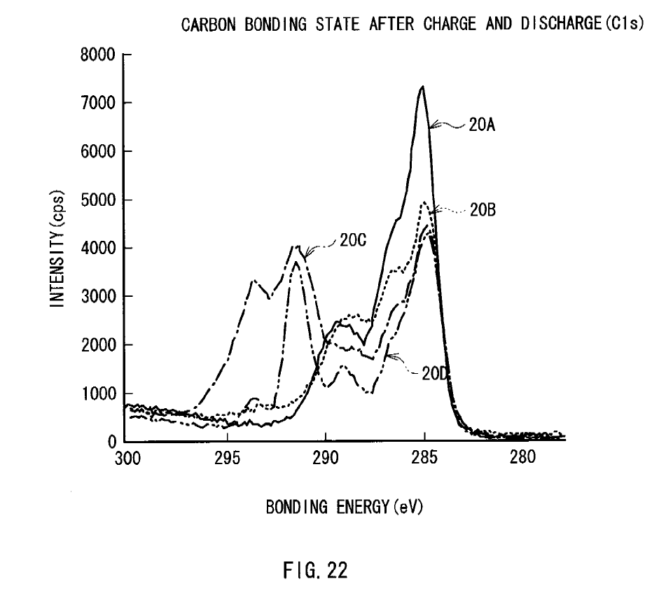

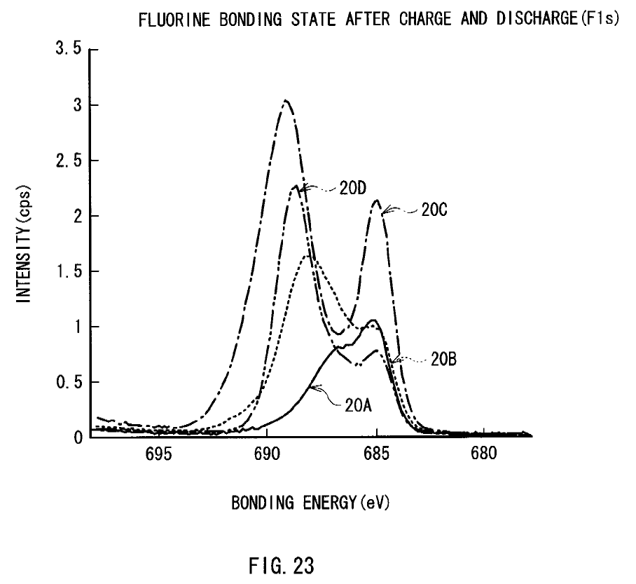

FIG. 20 shows a bonding state of carbon (1s orbit of carbon: C1s) before charge and discharge. FIG. 21 shows a bonding state of fluorine (1s orbit of fluorine: F1s) before charge and discharge. FIG. 22 shows a bonding state of carbon (C1s) after charge and discharge. FIG. 23 shows a bonding state of fluorine (F1s) after charge and discharge. Lines indicated by A to D in FIG. 20 to FIG. 23 respectively show Comparative example 12 and Examples 12-1 to 12-3.

In Comparative example 12 in which the coat 54C was not formed, a carbon bond and a fluorine bond in the fluorine resin were hardly observed before charge and discharge. More specifically, as shown in FIG. 20 (20A), a peak originated in the carbon bond in the fluorine resin was not observed, and as shown in FIG. 21 (21A), a peak originated in the fluorine bond in the fluorine resin was not observed.

Meanwhile, in Examples 12-1 to 12-3 in which the coat 54C was formed, a carbon bond and a fluorine bond in the fluorine resin were observed before charge and discharge. More specifically, as shown in FIG. 20, several peaks originated in the carbon bond in the fluorine resin were observed. In this case, in Example 12-1 (20B) using the fluorine resin shown in Chemical formula 1, the peak originated in —O—CF₂—CF₂—O— was observed around 294 eV. In Example 12-2 (20C) using the fluorine resin shown in Chemical formula 6, the peak originated in —CF₂—CF₂— was observed around 292 eV, and the peak originated in —CF₃ was observed around 294.6 eV. In Example 12-3 (20D) using the fluorine resin shown in Chemical formula 5, the peak originated in —CH₂— was observed around 286 eV, the peak originated in >C═O was observed around 290 eV, the peak originated in —CF₂—CF₂— was observed around 293 eV, and the peak originated in —CF₃ was observed around 295 eV. Further, as shown in FIG. 21, in any of Examples 12-1 to 12-3 (21B to 21D), a peak originated in the fluorine bond was observed around 690 eV.

Meanwhile, in Comparative example 12, a carbon bond and a fluorine bond in the fluorine resin were not observed after charge and discharge as well. More specifically, as shown in FIG. 22 (22A), only the peak originated in CH was observed around 285 eV; and as shown in FIG. 23 (23A), a peak originated in the fluorine bond in the fluorine resin was not observed.

Meanwhile, in Examples 12-1 to 12-3, after charge and discharge, together with the carbon bond and the fluorine bond in the fluorine resin, a fluorine bond in the fluoride particle was observed. More specifically, as shown in FIG. 22, in any of Examples 12-1 to 12-3 (22B to 22D), each peak shown in FIG. 20 was still observed. Further, as shown in FIG. 23, in any of Examples 12-1 to 12-3 (23B to 23D), each peak shown in FIG. 21 was still observed, and a peak originated in the fluorine bond in the fluoride particle (lithium fluoride) was newly observed around 685 eV. The intensity of each peak shown in FIG. 20 was lowered in FIG. 22. The reason thereof was that part of fluorine in the fluorine resin was consumed to form lithium fluoride, as evidenced by the fact that the peak showing formation of lithium fluoride was newly observed in FIG. 23.

As above, in FIG. 23, the peak showing formation of lithium fluoride was also observed in Comparative example 12 in which the coat 54C containing the fluorine resin was not formed. The reason thereof was as follows. That is, instead of the fluorine in the fluorine resin, fluorine in FEC as the solvent was reacted with lithium to form lithium fluoride. Focusing attention on only formation of lithium fluoride, the difference between Examples 12-1 to 12-3 and Comparative example 12 was only the difference between each fluorine supply source (coat 54 or FEC). However, according to the results of Table 12, though lithium fluoride was formed after charge and discharge both in Examples 12-1 to 12-3 and Comparative example 12, the discharge capacity retention ratio in Examples 12-1 to 12-3 was largely higher than that of Comparative example 12. The result showed that formation of lithium fluoride absolutely only complemented action to promote improvement of the discharge capacity retention ratio, and major part of the action to promote improvement of the discharge capacity retention ratio was generated by formation of the coat 54C containing the fluorine resin. That is, when only FEC was contained in the electrolytic solution as a fluorine supply source, the action to promote improvement of the discharge capacity retention ratio was not sufficiently obtained. However, when the coat 54C containing the fluorine resin was formed as a fluorine supply source, the action to promote improvement of the discharge capacity retention ratio was obtained to largely surpass the effect of FEC. Further, in the case where the coat 54C containing the fluorine resin was formed, fluorine in the fluorine resin was consumed to form particulate lithium fluoride. Meanwhile, in the case where the coat 54C containing the fluorine resin was not formed, fluorine in FEC was consumed to form lithium fluoride in a state of a film. Thus, the action of lithium fluoride to improve the discharge capacity retention ratio may be largely higher in the case of the particulate lithium fluoride than in the case of the lithium fluoride in a state of a film.

Further, focusing attention on only the fact that the coat containing the fluorine resin was provided on the anode active material layer 54B, such a state may occur in Comparative example 12 as well. Since the binder of the anode 54 was polyvinylidene fluoride in Comparative example 12, if the polyvinylidene fluoride existed to cover the anode active material, such a state might be close to the state that the coat containing the fluorine resin was provided on the anode active material layer 54B. However, in terms of the fact that the discharge capacity retention ratio of Examples 12-1 to 12-3 was largely higher than that of Comparative example 12 as described above, the action to promote improvement of the discharge capacity retention ratio was obtained to surpass the case not having an ether bond when the coat 54C having the fluorine resin was formed separately from the anode active material layer 54B and the fluorine resin had an ether bond.

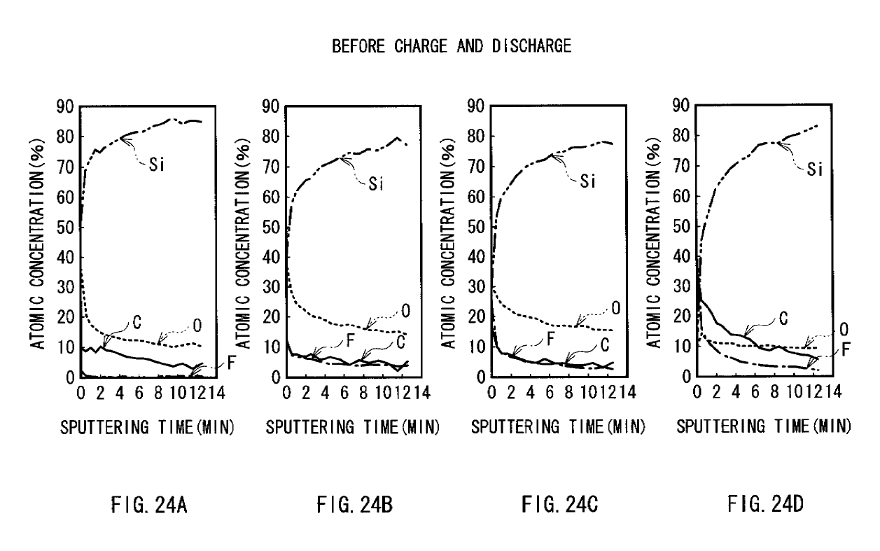

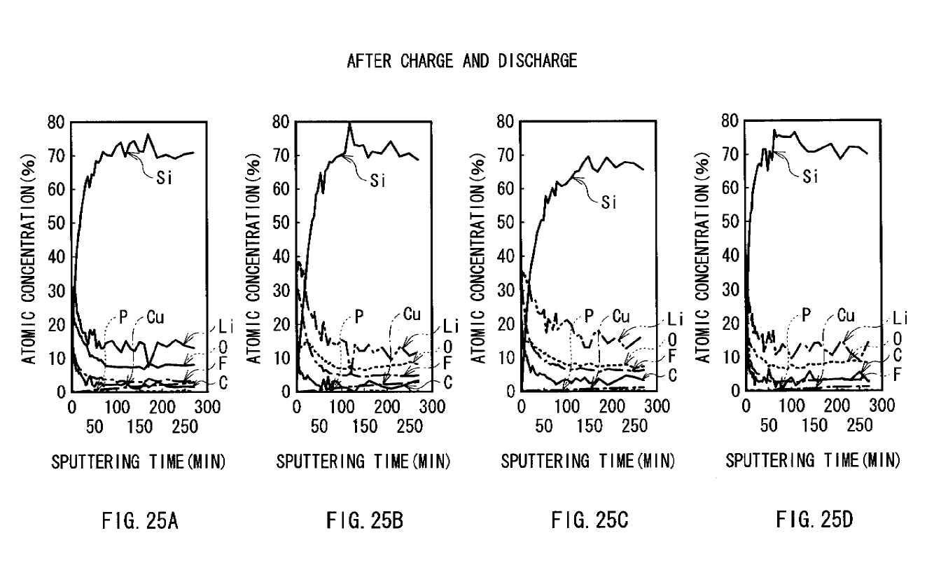

FIGS. 24A to 24D show distribution states of elements before charge and discharge and FIGS. 25A to 25D show distribution states of elements after charge and discharge. FIGS. 24A to 24D and FIGS. 25A to 25D respectively show Comparative example 12 and Examples 12-1 to 12-3. Symbols shown in FIGS. 24A to 24D and FIGS. 25A to 25D represent detected elements.

When the distribution states of elements were examined by XPS, results matching with the results obtained when the bonding states of elements were examined (refer to FIG. 20 to FIG. 23) were obtained. That is, in Comparative example 12 in which the coat 54C was not formed, before charge and discharge, as shown in FIG. 24A, only silicon was detected in the vicinity of the surface of the anode 54 and fluorine was hardly detected; while after charge and discharge, as shown in FIG. 25A, since fluorine in FEC was consumed to slightly form lithium fluoride, lithium and fluorine were detected together with silicon. Meanwhile, in Examples 12-1 to 12-3 in which the coat 54C was formed, before charge and discharge, as shown in FIGS. 24B to 24D, fluorine together with silicon was detected in the vicinity of the surface of the anode 54; while after charge and discharge, as shown in FIGS. 25B to 25D, since fluorine in the fluorine resin was consumed to form lithium fluoride, lithium and fluorine were detected together with silicon.

From the XPS measurement results shown in FIG. 20 to FIG. 25D, it was confirmed that the coat might be formed on the anode active material layer by using the fluorine resin having an ether bond, and the discharge capacity retention ratio was improved due to existence of the coat. Further, it was confirmed that when the foregoing coat was formed, the fluoride particle generated through charge and discharge further improved the discharge capacity retention ratio.

### Examples 13-1 to 13-6

A procedure was performed in the same manner as that of Example 2-7, except that the oxygen content in the anode active material particle was changed to 2 atomic % (Example 13-1), 10 atomic % (Example 13-2), 20 atomic % (Example 13-3), 30 atomic % (Example 13-4), 40 atomic % (Example 13-5), or 45 atomic % (Example 13-6).

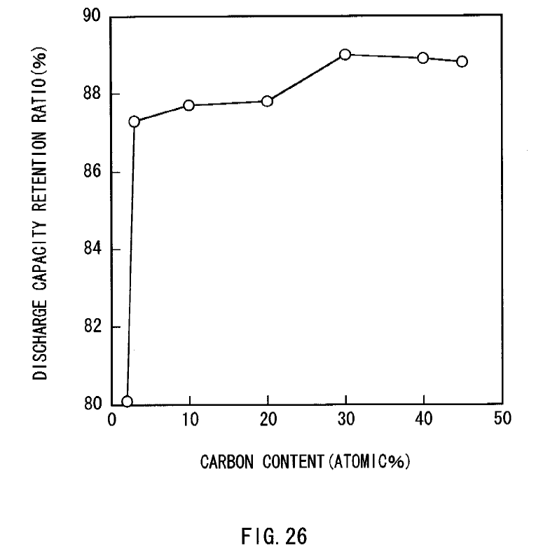

When the cycle characteristics of the secondary batteries of Examples 13-1 to 13-6 were examined, the results shown in Table 13 and FIG. 26 were obtained.

TABLE 13
Anode active material: silicon (electron beam evaporation method)
Ten points average height of roughness profile Rz = 3.5 μm

| | Anode active material layer | | | | | |
|---|---|---|---|---|---|---|
| | Number of | | | | | |
| | layers of | | Coat | | | Discharge |
| | anode active | | | | Number of | capacity |
| | material | Oxygen | | Spray | fluoride | retention |
| | particle | content | Type of | amount | particles | ratio |
| | (layer) | (atomic %) | fluorine resin | (mg/cm²) | (pcs) | (%) |
| Example | 6 | 2 | Chemical | 0.086 | 300 | 80.1 |
| 13-1 | | | formula 1 | | | |
| Example 2-7 | | 3 | | | | 87.3 |
| Example | | 10 | | | | 87.7 |
| 13-2 | | | | | | |
| Example | | 20 | | | | 87.8 |
| 13-3 | | | | | | |
| Example | | 30 | | | | 89 |
| 13-4 | | | | | | |
| Example | | 40 | | | | 88.9 |
| 13-5 | | | | | | |
| Example | | 45 | | | | 88.8 |
| 13-6 | | | | | | |
| Comparative | 6 | 3 | — | — | — | 45.5 |
| example 2 | | | | | | |

As shown in Table 13 and FIG. 26, in Examples 13-1 to 13-6 in which the oxygen content in the anode active material particle was different, the discharge capacity retention ratio was largely higher as in Example 2-7 than that of Comparative example 2. In this case, as the oxygen content was increased, the discharge capacity retention ratio tended to be increased and then decreased. When the oxygen content was smaller than 3 atomic %, the discharge capacity retention ratio was largely lowered. However, when the oxygen content was larger than 40 atomic %, the battery capacity was lowered though a sufficient discharge capacity retention ratio was obtained. Accordingly, it was confirmed that in the secondary battery of the invention, the cycle characteristics were improved even when the oxygen content in the anode active material was changed. Further, it was confirmed that when the oxygen content was in the range from 3 atomic % to 40 atomic %, higher effects were obtained.

### Examples 14-1 to 14-3

A procedure was performed in the same manner as that of Example 2-7, except that the anode active material particle was formed so that the first oxygen-containing region and the second oxygen-containing region having a higher oxygen content than that of the first oxygen-containing region were alternately layered by depositing silicon while intermittently introducing oxygen gas or the like into a chamber. The oxygen content in the second oxygen-containing region was 3 atomic %, and the number thereof was 2 (Example 14-1), 4 (Example 14-2), or 6 (Example 14-3).

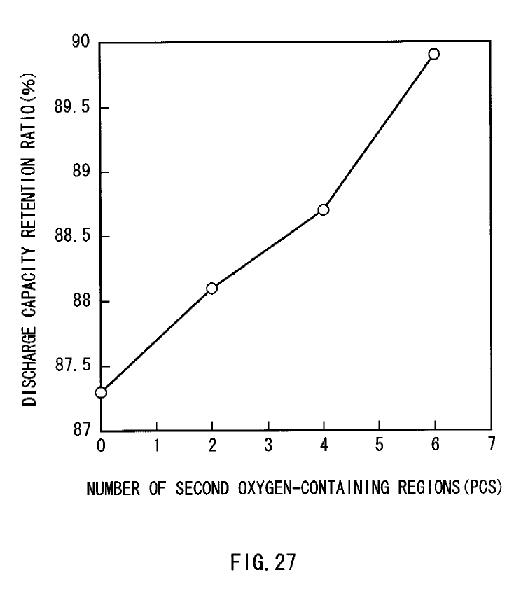

When the cycle characteristics of the secondary batteries of Examples 14-1 to 14-3 were examined, the results shown in Table 14 and FIG. 27 were obtained.

TABLE 14
Anode active material: silicon (electron beam evaporation method)
Ten points average height of roughness profile Rz = 3.5 μm

| | Anode active material layer | | | | | |
|---|---|---|---|---|---|---|
| | Number of | | | | | |
| | layers of | | Coat | | | Discharge |
| | anode active | Number of second | | | Number of | capacity |
| | material | oxygen-containing | Type of | Spray | fluoride | retention |
| | particle | regions | fluorine | amount | particles | ratio |
| | (layer) | (pcs) | resin | (mg/cm²) | (pcs) | (%) |
| Example 2-7 | 6 | — | Chemical | 0.086 | 300 | 87.3 |
| Example 14-1 | | 2 | formula 1 | | | 88.1 |
| Example 14-2 | | 4 | | | | 88.7 |
| Example 14-3 | | 6 | | | | 89.9 |
| Comparative | 6 | 3 | — | — | — | 45.5 |
| example 2 | | | | | | |

As shown in Table 14 and FIG. 27, in Examples 14-1 to 14-3 in which the anode active material particle had the first and the second oxygen-containing regions, the discharge capacity retention ratio was largely higher as in Example 2-7 than that of Comparative example 2. In this case, the discharge capacity retention ratio of Examples 14-1 to 14-3 was higher than that of Example 2-7. As the number of the second oxygen-containing regions was increased, the discharge capacity retention ratio tended to be higher. Accordingly, it was confirmed that in the secondary battery of the invention, the cycle characteristics were also improved when the anode active material particle had the first and the second oxygen-containing regions. Further, it was confirmed that as the number of the second oxygen-containing regions was increased, higher effects were obtained.

### Examples 15-1 to 15-6

A procedure was performed in the same manner as that of Example 2-7, except that the anode active material particle containing both silicon and a metal element was formed by using silicon with purity of 99% and the metal element with purity of 99.9% as evaporation sources. As the metal element, iron (Example 16-1), nickel (Example 15-2), molybdenum (Example 15-3), titanium (Example 15-4), chromium (Example 16-6), or cobalt (Example 15-6) was used. The evaporation amount of the metal element was adjusted so that the content of the metal element in the anode active material particle was 10 atomic %.

When the cycle characteristics of the secondary batteries of Examples 16-1 to 15-6 were examined, the results shown in Table 15 were obtained.

TABLE 15
Anode active material: silicon (electron beam evaporation method)
Ten points average height of roughness profile Rz = 3.5 μm
Oxygen content in the anode active material particle: 3 atomic %
Content of Metal element in the anode active material particle: 10 atomic %

| | Anode active material layer | | | | | |
|---|---|---|---|---|---|---|
| | Number of | | Coat | | | Discharge |
| | layers of anode | | | | Number of | capacity |
| | active material | | | | fluoride | retention |
| | particle | Metal | Type of | Spray amount | particles | ratio |
| | (layer) | element | fluorine resin | (mg/cm²) | (pcs) | (%) |
| Example 2-7 | 6 | — | Chemical | 0.086 | 300 | 87.3 |
| Example | | Fe | formula 1 | | | 90.5 |
| 15-1 | | | | | | |
| Example | | Ni | | | | 89.4 |
| 15-2 | | | | | | |
| Example | | Mo | | | | 89.3 |
| 15-3 | | | | | | |
| Example | | Ti | | | | 89.7 |
| 15-4 | | | | | | |
| Example | | Cr | | | | 89.5 |
| 15-5 | | | | | | |
| Example | | Co | | | | 90.6 |
| 15-6 | | | | | | |
| Comparative | 6 | 3 | — | — | — | 45.5 |
| example 2 | | | | | | |

As shown in Table 15, in Examples 15-1 to 15-6 in which the anode active material particle contained the metal element together with silicon, the discharge capacity retention ratio was largely higher as in Example 2-7 than that of Comparative example 2. In this case, the discharge capacity retention ratio tended to be higher than that of Example 1-8. Accordingly, it was confirmed that in the secondary battery of the invention, the cycle characteristics were also improved when the anode active material particle contained the metal element. Further, it was confirmed that when the metal element was contained, higher effects were obtained.

### Example 16-1

A procedure was performed in the same manner as that of Example 2-7, except that the anode active material particle was formed by RF magnetron sputtering method. At that time, silicon with purity of 99.99% was used as a target, the deposition rate was 0.5 nm/sec, and the total thickness of the anode active material particle was 7.5 μm.

### Example 16-2

A procedure was performed in the same manner as that of Example 2-7, except that the anode active material particle was deposited by CVD method. At that time, silane and argon were used respectively as a raw material and excitation gas, the deposition rate and the substrate temperature were respectively 1.5 nm/sec and 200 deg C., and the total thickness of the anode active material particle was 7.5 μm.

When the cycle characteristics of the secondary batteries of Examples 16-1 and 16-2 were examined, the results shown in Table 16 were obtained.

TABLE 16
Anode active material: silicon
Ten points average height of roughness profile Rz = 3.5 μm
Oxygen content in the anode active material particle = 3 atomic %

| | Anode active material layer | | | | | |
|---|---|---|---|---|---|---|
| | Number of | | | | | |
| | layers of | | | | | |
| | anode | | Coat | | | Discharge |
| | active | | | | Number of | capacity |
| | material | | Type of | Spray | fluoride | retention |
| | particle | Forming | fluorine | amount | particles | ratio |
| | (layer) | method | resin | (mg/cm²) | (pcs) | (%) |
| Example 2-7 | 6 | Electron beam | Chemical | 0.086 | 300 | 87.3 |
| | | evaporation | formula 1 | | | |
| | | method | | | | |
| Example | | Sputtering | | | | 87 |
| 16-1 | | method | | | | |
| Example | | CVD method | | | | 86.5 |
| 16-2 | | | | | | |
| Comparative | 6 | Electron beam | — | — | — | 45.5 |
| example 2 | | evaporation | | | | |
| | | method | | | | |

As shown in Table 16, in Examples 16-1 and 16-2 in which the method of forming the anode active material particle was different, the discharge capacity retention ratio was higher as in Example 2-7 than that of Comparative example 2. In this case, the discharge capacity retention ratio tended to be increased in the order of CVD method, sputtering method, and electron beam evaporation method. Accordingly, it was confirmed that in the secondary battery of the invention, the cycle characteristics were also improved when the method of forming the anode active material particle was changed. Further, it was confirmed that when evaporation method was used, higher effects were obtained.

### Examples 17-1 to 17-7

A procedure was performed in the same manner as that of Example 2-7, except that the ten points average height of roughness profile Rz of the surface of the anode current collector 54A was changed to 1 μm (Example 17-1), 1.5 μm (Example 17-2), 2.5 μm (Example 17-3), 4.5 μm (Example 17-4), 5.5 μm (Example 17-5), 6.5 μm (Example 17-6), or 7 μm (Example 17-7).

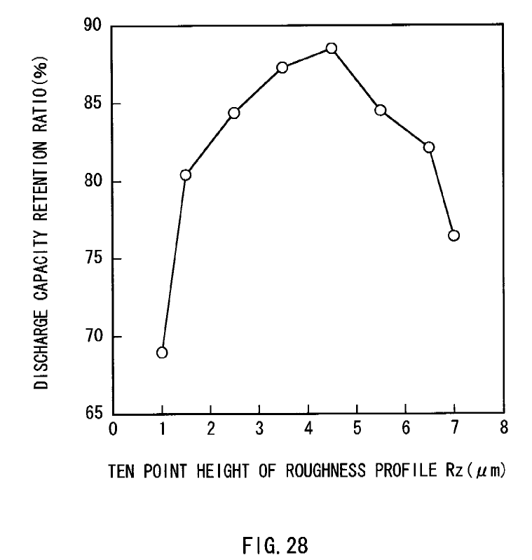

When the cycle characteristics of the secondary batteries of Examples 17-1 to 17-7 were examined, the results shown in Table 17 and FIG. 28 were obtained.

TABLE 17
Anode active material: silicon (electron beam evaporation method)
Oxygen content in the anode active material particle = 3 atomic %

| | Anode | | | | | |
|---|---|---|---|---|---|---|
| | active | | | | | |
| | material | | | | | |
| | layer | Anode current | | | | |
| | Number of | collector | | | | |
| | layers of | Ten points | | | | |
| | anode | average | Coat | | | Discharge |
| | active | height of | | | Number of | capacity |
| | material | roughness | Type of | Spray | fluoride | retention |
| | particle | profile Rz | fluorine | amount | particles | ratio |
| | (layer) | (μm) | resin | (mg/cm²) | (pcs) | (%) |
| Example | 6 | 1 | Chemical | 0.086 | 300 | 69 |
| 17-1 | | | formula 1 | | | |
| Example | | 1.5 | | | | 80.4 |
| 17-2 | | | | | | |
| Example | | 2.5 | | | | 84.4 |
| 17-3 | | | | | | |
| Example 2-7 | | 3.5 | | | | 87.3 |
| Example | | 4.5 | | | | 88.5 |
| 17-4 | | | | | | |
| Example | | 5.5 | | | | 84.5 |
| 17-5 | | | | | | |
| Example | | 6.5 | | | | 82.1 |
| 17-6 | | | | | | |
| Example | | 7 | | | | 76.4 |
| 17-7 | | | | | | |
| Comparative | 6 | 3.5 | — | — | — | 45.5 |
| example 2 | | | | | | |

As shown in Table 17 and FIG. 28, in Examples 17-1 to 17-7 in which the ten points average height of roughness profile Rz was different, the discharge capacity retention ratio was largely higher as in Example 2-7 than that of Comparative example 2. In this case, as the ten points average height of roughness profile Rz was increased, the discharge capacity retention ratio tended to be increased and then decreased. When the ten points average height of roughness profile Rz was smaller than 1.5 μm or larger than 6.5 μm, the discharge capacity retention ratio was extremely lowered. Accordingly, it was confirmed that in the secondary battery of the invention, the cycle characteristics were also improved when the ten points average height of roughness profile Rz of the surface of the anode current collector 54A was changed. Further, it was confirmed that when the ten points average height of roughness profile Rz was in the range from 1.5 μm to 6.5 μm, higher effects were obtained.

### Example 18-1

A procedure was performed in the same manner as that of Example 2-7, except that FEC was used instead of EC as a solvent.

### Example 18-2

A procedure was performed in the same manner as that of Example 2-7, except that 4,5-difluoro-1,3-dioxolane-2-one (DFEC) as fluorinated ester carbonate (difluoroethylene carbonate) was added as a solvent, and the composition of the mixed solvent (EC:DFEC:DEC) was 25:5:70 at a weight ratio.

### Examples 18-3 and 18-4

A procedure was performed in the same manner as that of Example 18-1, except that vinylene carbonate (VC: Example 18-3) or vinylethylene carbonate (VEC: Example 18-4) that was a cyclic ester carbonate having an unsaturated bond was added as a solvent to the electrolytic solution. The content of VC or VEC in the electrolytic solution was 10 wt %.

### Example 18-5

A procedure was performed in the same manner as that of Example 18-1, except that 1,3-propene sultone (PRS) as sultone was added as a solvent to the electrolytic solution. The concentration of PRS in the electrolytic solution was 1 wt %.

### Example 18-6

A procedure was performed in the same manner as that of Example 18-1, except that lithium tetrafluoroborate (LiBF₄) was added as an electrolyte salt to the electrolytic solution. The concentration of LiBF₄ in the electrolytic solution was 0.1 mol/kg.

When the cycle characteristics were examined for the secondary batteries of Examples 18-1 to 18-6, the results shown in Table 18 were obtained.

For the secondary batteries of Examples 2-7 and 18-5, not only the cycle characteristics but also the swollenness characteristics were examined. The swollenness characteristics were examined as follows. The thickness in the atmosphere at 23 deg C. (thickness before charge) was measured. Charge was continuously performed in the same atmosphere, and the thickness (thickness after charge) was measured. After that, the swollenness ratio (%)=[(thickness after charge−thickness before charge)/thickness before charge]×100 was calculated. The charge condition was similar to that in the case that the cycle characteristics were examined.

TABLE 18
Anode active material particle: silicon (electron beam evaporation method)
Ten points average height of roughness profile Rz = 3.5 μm
Oxygen content in the anode active material particle = 3 atomic %

| | Anode active | | | | | | | | | | |
|---|---|---|---|---|---|---|---|---|---|---|---|
| | material | | | | | | | | | | |
| | layer | | | | | | | | | | |
| | Number of | | | | | | | | | | |
| | layers of | Coat | | | | | | | | Discharge | |
| | anode active | | | Number | Electrolytic solution | | | | | capacity | |
| | material | | | of fluoride | Solvent | | | | | retention | Swollenness |
| | particle | Type of | Spray amount | particles | (wt %) | | | | | ratio | ratio |
| | (layer) | fluorine resin | (mg/cm²) | (pcs) | EC | FEC | DFEC | DEC | Others | (%) | (%) |
| Example 2-7 | 6 | Chemical | 0.086 | 300 | 50 | — | — | 50 | — | 87.3 | 3.00 |
| Example | | formula 1 | | | — | 50 | — | 50 | | 89.5 | — |
| 18-1 | | | | | | | | | | | |
| Example | | | | | 25 | — | 5 | 70 | | 89.6 | — |
| 18-2 | | | | | | | | | | | |
| Example | | | | | — | 50 | — | 50 | VC | 90.1 | — |
| 18-3 | | | | | | | | | | | |
| Example | | | | | | | | | VEC | 89.9 | — |
| 18-4 | | | | | | | | | | | |
| Example | | | | | | | | | PRS | 88.5 | 0.40 |
| 18-5 | | | | | | | | | | | |
| Example | | | | | | | | | LIBF₄ | 88.6 | — |
| 18-6 | | | | | | | | | | | |
| Comparative | 6 | — | — | — | 50 | — | — | 50 | — | 45.5 | — |
| example 2 | | | | | | | | | | | |

As shown in Table 18, in Examples 18-1 to 18-6 in which the solvent composition and the electrolyte salt type were different, the discharge capacity retention ratio was largely higher as in Example 2-7 than that of Comparative example 2. In this case, the discharge capacity retention ratio was high when the solvent contained FEC or DFEC. The discharge capacity retention ratio when VC, VEC, PRS or LIBF₄ was further contained was almost equal to or higher than that in the case of containing FEC or DFEC. In particular, in the former case, the discharge capacity retention ratio in the case of containing DFEC was higher than that in the case of containing FEC. In the latter case, the discharge capacity retention ratio in the case of containing VC or VEC was higher than that in the case of containing PRS or LiBF₄. Further, when the solvent contained PRS, the swollenness ratio was largely smaller than that of the case in which the solvent did not contain PRS. Accordingly, it was confirmed that in the secondary battery of the invention, the cycle characteristics were also improved when the solvent composition and the electrolyte salt type were changed. In this case, it was confirmed that when the solvent contained the fluorinated ester carbonate, the cycle characteristics were further improved. Further, it was confirmed that difluoroethylene carbonate was more preferably used than monofluoroethylene carbonate as the fluorinated ester carbonate. Further, it was confirmed that when the cyclic ester carbonate having an unsaturated bond, sultone, or the electrolyte salt containing boron and fluorine was contained in the solvent, the cycle characteristics were further improved. Further, when the cyclic ester carbonate having an unsaturated bond was used, higher effects were obtained. Furthermore, when the solvent contained sultone, the swollenness characteristics were improved.

### Example 19-1

A procedure was performed in the same manner as that of Example 2-7, except that the square secondary battery shown in FIG. 9 to FIG. 11 was manufactured by the following procedure.

First, the cathode 21 and the anode 22 were formed. After that, the cathode lead 24 made of aluminum and the anode lead 25 made of nickel were respectively welded to the cathode current collector 21A and the anode current collector 22A. Subsequently, the cathode 21, the separator 23, and the anode 22 were layered in this order, and spirally wound in the longitudinal direction, and then formed in the flat shape. Thereby, the battery element 20 was formed. Subsequently, the battery element 20 was contained in the battery can 11 made of aluminum. After that, the insulating plate 12 was arranged on the battery element 20. Subsequently, the cathode lead 24 and the anode lead 25 were respectively welded to the cathode pin 15 and the battery can 11. After that, the battery cover 13 was fixed to the open end of the battery can 11 by laser welding. Finally, the electrolytic solution was injected into the battery can 11 through the injection hole 19. After that, the injection hole 19 was sealed by the sealing member 19A, and thereby the square battery was completed.

### Example 19-2

A procedure was performed in the same manner as that of Example 19-1, except that the battery can 11 made of iron was used instead of the battery can 11 made of aluminum.

When the cycle characteristics of the secondary batteries of Examples 19-1 and 19-2 were examined, the results shown in Table 19 were obtained.

TABLE 19
Anode active material particle: silicon (electron beam evaporation method)
Ten points average height of roughness profile Rz = 3.5 μm
Oxygen content in the anode active material particle = 3 atomic %

| | | Anode | | | | |
|---|---|---|---|---|---|---|
| | | active | | | | |
| | | material | | | | |
| | | layer | | | | |
| | | Number of | | | | |
| | | layers of | | | | |
| | | anode | Coat | | | |
| | | active | | | Number of | |
| | | material | Type of | | fluoride | Discharge capacity |
| | Battery | particle | fluorine | Spray amount | particles | retention ratio |
| | structure | (layer) | resin | (mg/cm²) | (pcs) | (%) |
| Example 2-7 | Laminated | 6 | Chemical | 0.086 | 300 | 87.3 |
| | film | | formula 1 | | | |
| Example | Square | | | | | 89.5 |
| 19-1 | (aluminum) | | | | | |
| Example | Square | | | | | 91.1 |
| 19-2 | (iron) | | | | | |
| Comparative | Laminated | 6 | — | — | — | 45.5 |
| example 2 | film | | | | | |

As shown in Table 19, in Examples 19-1 and 19-2 in which the battery structure was different, the discharge capacity retention ratio was largely higher as in Example 2-7 than that of Comparative example 2. In this case, the discharge capacity retention ratio of Examples 19-1 and 19-2 tended to be higher than that of Example 2-7, and the discharge capacity retention ratio in the case that the battery can 11 was made of iron was higher than that in the case that the battery can 11 was made of aluminum. Accordingly, it was confirmed that in the secondary battery of the invention, the cycle characteristics were also improved when the battery structure was changed. Further, it was confirmed that in the case that the battery structure was the square type, the cycle characteristics were more improved than that in the case that the battery structure was the laminated film type, and higher effects were obtained in the case that the battery can 11 made of iron was used. Though no specific examples for a cylindrical secondary battery in which the package member is made of a metal material have been herein given, it is evident that similar effects were obtained in such a cylindrical secondary battery since the cycle characteristics and the swollenness characteristics were improved in the square secondary battery including the package member made of the metal material than in the laminated film secondary battery.

### Example 20-1

A procedure was performed in the same manner as that of Example 2-7, except that the anode active material layer 54B was formed to contain a metal together with the anode active material particle. In this case, the anode active material particle was formed on the both faces of the anode current collector 54A. After that, the metal was formed on the both faces by growing a cobalt plating film by electrolytic plating method. As a plating solution, a cobalt plating solution of Japan Pure Chemical Co., Ltd. was used. The current density was in the range from 2 A/dm² to 5 A/dm², and the plating rate was 10 nm/sec. Further, the ratio (molar ratio) M2/M1 of the number of moles M2 per unit area of the metal in relation to the number of moles M1 per unit area of the anode active material particle was 1/20.

### Examples 20-2 to 20-11

A procedure was performed in the same manner as that of Example 20-1, except that the molar ratio M2/M1 was 1/15 (Example 20-2), 1/10 (Example 20-3), 1/5 (Example 20-4), 1/2 (Example 20-5), 1/1 (Example 20-6), 2/1 (Example 20-7), 3/1 (Example 20-8), 5/1 (Example 20-9), 7/1 (Example 20-10), or 8/1 (Example 20-11).

### Examples 20-12 to 20-15

A procedure was performed in the same manner as that of Example 20-5, except that an iron plating solution (Example 20-12), a nickel plating solution (Example 20-13), a zinc plating solution (Example 20-14), or a copper plating solution (Example 20-15) was used instead of the cobalt plating solution as a plating solution. The current density was in the range from 2 A/dm² to 5 A/dm² in the case of using the iron plating solution, in the range from 2 A/dm² to 10 A/dm² in the case of using the nickel plating solution, in the range from 1 A/dm² to 3 A/dm² in the case of using the zinc plating solution, and in the range from 2 A/dm² to 8 A/dm² in the case of using the copper plating solution. All the foregoing plating solutions are made by Japan Pure Chemical Co., Ltd.

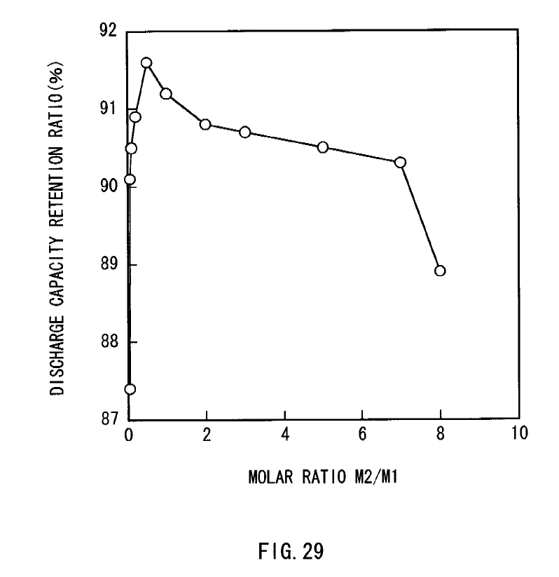

When the cycle characteristics of the secondary batteries of Examples 20-1 to 20-15 were examined, the results shown in Table 20 and FIG. 29 were obtained.

TABLE 20
Anode active material: silicon (electron beam evaporation method)
Ten points average height of roughness profile Rz = 3.5 μm
Oxygen content in the anode active material particle = 3 atomic %

| | Anode active material layer | | | | | | |
|---|---|---|---|---|---|---|---|
| | Number of | | | | | | |
| | layers of | | | Coat | | | Discharge |
| | anode active | | | | | Number of | capacity |
| | material | | Molar | | Spray | fluoride | retention |
| | particle | | ratio | Type of fluorine | amount | particles | ratio |
| | (layer) | Metal type | M2/M1 | resin | (mg/cm²) | (pcs) | (%) |
| Example 2-7 | 6 | — | — | Chemical formula 1 | 0.086 | 300 | 87.3 |
| Example 20-1 | | Co | 1/20 | | | | 87.4 |
| Example 20-2 | | | 1/15 | | | | 90.1 |
| Example 20-3 | | | 1/10 | | | | 90.5 |
| Example 20-4 | | | 1/5 | | | | 90.9 |
| Example 20-5 | | | 1/2 | | | | 91.6 |
| Example 20-6 | | | 1/1 | | | | 91.2 |
| Example 20-7 | | | 2/1 | | | | 90.8 |
| Example 20-8 | | | 3/1 | | | | 90.7 |
| Example 20-9 | | | 5/1 | | | | 90.5 |
| Example | | | 7/1 | | | | 90.3 |
| 20-10 | | | | | | | |
| Example | | | 8/1 | | | | 88.9 |
| 20-11 | | | | | | | |
| Example | | Fe | 1/2 | | | | 90.9 |
| 20-12 | | | | | | | |
| Example | | Ni | | | | | 90.8 |
| 20-13 | | | | | | | |
| Example | | Zn | | | | | 90.5 |
| 20-14 | | | | | | | |
| Example | | Cu | | | | | 90.6 |
| 20-15 | | | | | | | |

As shown in Table 20 and FIG. 29, in Examples 20-1 to 20-11 in which the metal was formed, the discharge capacity retention ratio thereof was higher than that of Example 2-7 in which the metal was not formed. In this case, when the molar ratio M2/M1 was smaller than 1/15 or larger than 7/1, the discharge capacity retention ratio tended to be largely lowered down to less than 90%. Further, when Examples 20-5 and 20-12 to 20-15 having the different metal types were compared to each other, the discharge capacity retention ratio tended to be higher in the case that cobalt was used than in the case that iron, nickel, zinc, or copper was used as the metal. Thereby, it was confirmed that in the secondary battery of the invention, when the metal not reacting with the electrode reactant was formed after the anode active material was formed, the cycle characteristics were improved. It was also confirmed that when the molar ratio was in the range from 1/15 to 7/1 or when cobalt was used as the metal, higher effects were obtained.

As evidenced by the results of the foregoing Table 1 to Table 20 and FIG. 17 to FIG. 29, it was confirmed that when the coat containing the fluorine resin having an ether bond was provided on the anode active material, the cycle characteristics were improved not depending on the conditions such as the structures of the anode current collector and the anode active material layer, the composition of the electrolytic solution, and the type of the battery structure.

The invention has been described with reference to the embodiment and the examples. However, the invention is not limited to the aspects described in the foregoing embodiment and the foregoing examples, and various modifications may be made. For example, in the foregoing embodiment and the foregoing examples, the descriptions have been given of the lithium ion secondary battery in which the anode capacity is expressed based on insertion and extraction of lithium as a battery type. However, the battery of the invention is not limited thereto. The invention is similarly applicable to a secondary battery in which the anode capacity includes the capacity based on insertion and extraction of lithium and the capacity based on precipitation and dissolution of lithium, and the anode capacity is expressed as the sum of these capacities, by setting the charge capacity of the anode material capable of inserting and extracting lithium to a smaller value than that of the charge capacity of the cathode.

Further, in the foregoing embodiment and the foregoing examples, the description has been given with the specific examples of the square, cylindrical, or laminated film secondary battery as a battery structure, and with the specific example of the battery in which the battery element has the spirally wound structure. However, the invention is similarly applicable to a battery having other structure such as a coin type battery and a button type battery, or a battery in which the battery element has other structure such as a lamination structure. The battery of the invention is similarly applicable to other type of battery such as a primary battery in addition to the secondary battery.

Further, in the foregoing embodiment and the foregoing examples, the description has been given of the case using lithium as an electrode reactant. However, as an electrode reactant, other Group 1A element such as sodium (Na) and potassium (K), a Group 2A element such as magnesium (Mg) and calcium (Ca), or other light metal such as aluminum may be used. In these cases, the anode material described in the foregoing embodiment may be also used as an anode active material.

Further, in the foregoing embodiment and the foregoing examples, regarding the number of fluoride particles of the electrode reactant in the anode or the battery of the invention, the numerical value range thereof derived from the results of the examples has been described as the appropriate range. However, such a description does not totally eliminate the possibility that the foregoing number may be out of the foregoing range. That is, the foregoing appropriate range is the range particularly preferable for obtaining the effects of the invention. Therefore, as long as effects of the invention are obtained, the foregoing number may be out of the foregoing range in some degrees. The same is applied to the oxygen content in the anode active material, the ten points average height of roughness profile Rz of the surface of the anode current collector, the ratio between the molar ratio per unit area of the anode active material particle and the molar ratio per unit area of the metal and the like, in addition to the foregoing number.

It should be understood by those skilled in the art that various modifications, combinations, sub-combinations and alternations may occur depending on design requirements and other factors insofar as they are within the scope of the appended claims or the equivalents thereof.

What is claimed is:

1. An anode comprising:
an anode current collector;
an anode active material layer provided on the anode current collector; and
a coat provided on the anode active material layer, wherein the coat contains a fluorine resin having an ether bond (—O—).

2. The anode according to claim 1, wherein the fluorine resin is at least one selected from the group consisting of polymer compounds shown in Chemical formula 1, Chemical formula 2, Chemical formula 3, Chemical formula 4, Chemical formula 5, and Chemical formula 6: 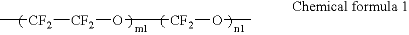
where m1 and n1 are one of integer numbers 1 or higher; 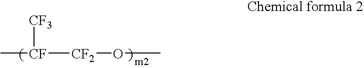
where m2 is one of integer numbers 1 or higher; 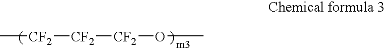
where m3 is one of integer numbers 1 or higher; 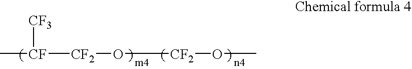
where m4 and n4 are one of integer numbers 1 or higher; 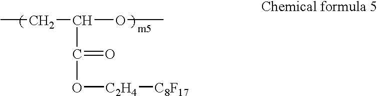
where m5 is one of integer numbers 1 or higher; 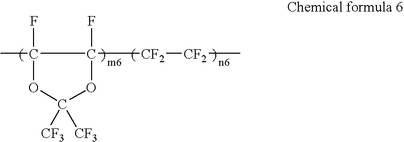
where m6 and n6 are one of integer numbers 1 or higher.

3. The anode according to claim 1, wherein the fluorine resin is perfluoropolyether.

4. The anode according to claim 1, wherein a fluoride particle of an electrode reactant exists on a surface of the coat.

5. The anode according to claim 4, wherein the anode active material layer contains a plurality of anode active material particles, and the number of the fluoride particle of the electrode reactant per 1 particle of the anode active material particles is in the range from 4 to 500.

6. The anode according to claim 1, wherein the anode active material layer contains a plurality of anode active material particles, and the coat is an oil film having a cross-linked structure between the anode active material particles adjacent to each other.

7. The anode according to claim 1, wherein the anode active material layer contains an anode active material containing silicon (Si) or tin (Sn).

8. The anode according to claim 7, wherein the anode active material contains oxygen (O), and a content of the oxygen in the anode active material is in the range from 3 atomic % to 40 atomic %.

9. The anode according to claim 7, wherein the anode active material contains at least one metal element selected from the group consisting of iron (Fe), cobalt (Co), nickel (Ni), chromium (Cr), titanium (Ti), and molybdenum (Mo).

10. The anode according to claim 7, wherein the anode active material has an oxygen-containing region containing oxygen in the thickness direction, and a content of the oxygen in the oxygen-containing region is higher than a content of oxygen in other regions.

11. The anode according to claim 1, wherein ten points average height of roughness profile Rz of a surface of the anode current collector is in the range from 1.5 μm to 6.5 μm.

12. The anode according to claim 1, wherein the anode active material layer contains a plurality of anode active material particles.

13. The anode according to claim 12, wherein the anode active material particles have a multilayer structure in the particles.

14. The anode according to claim 12, wherein the anode active material particles are formed by vapor-phase deposition method.

15. The anode according to claim 12, wherein the anode active material layer contains a metal not being alloyed with an electrode reactant.

16. The anode according to claim 15, wherein the anode active material layer has the metal in a gap between the anode active material particles adjacent to each other.

17. The anode according to claim 15, wherein the anode active material layer has the metal in at least part of an exposed face of the anode active material particles.

18. The anode according to claim 15, wherein the anode active material particles have a multilayer structure in the particles, and the anode active material layer has the metal in a gap in the anode active material particles.

19. The anode according to claim 15, wherein the metal contains at least one metal element selected from the group consisting of iron, cobalt, nickel, zinc (Zn), and copper (Cu).

20. The anode according to claim 15, wherein ratio M2/M1 of the number of moles M2 per unit area of the metal in relation to the number of moles M1 per unit area of the anode active material particles is in the range from 1/15 to 7/1.

21. The anode according to claim 15, wherein the metal is formed by liquid-phase deposition method.

22. A battery comprising:
a cathode;
an anode; and
an electrolytic solution,
wherein the anode has an anode current collector,
an anode active material layer provided on the anode current collector, and
a coat provided on the anode active material layer, wherein the coat contains a fluorine resin having an ether bond.

23. The battery according to claim 22, wherein the fluorine resin is at least one selected from the group consisting of polymer compounds shown in Chemical formula 7, Chemical formula 8, Chemical formula 9, Chemical formula 10, Chemical formula 11, and Chemical formula 12: 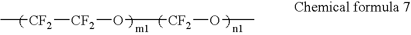
where m1 and n1 are one of integer numbers 1 or higher; 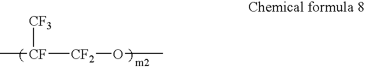
where m2 is one of integer numbers 1 or higher; 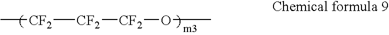
where m3 is one of integer numbers 1 or higher; 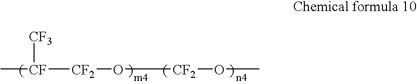
where m4 and n4 are one of integer numbers 1 or higher; 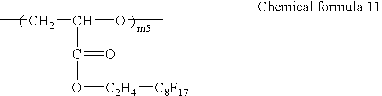
where m5 is one of integer numbers 1 or higher; 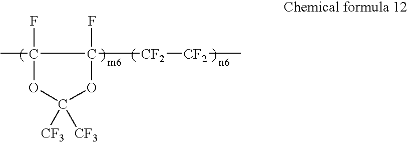
where m6 and n6 are one of integer numbers 1 or higher.

24. The battery according to claim 22, wherein the fluorine resin is perfluoropolyether.

25. The battery according to claim 22, wherein a fluoride particle of an electrode reactant exists on a surface of the coat.

26. The battery according to claim 25, wherein the anode active material layer contains a plurality of anode active material particles, and the number of the fluoride particle of the electrode reactant per 1 particle of the anode active material particles is in the range from 4 to 500.

27. The battery according to claim 25, wherein the electrode reactant contains lithium (Li), and the fluoride particle of the electrode reactant contains lithium fluoride (LiF).

28. The battery according to claim 22, wherein the anode active material layer contains a plurality of anode active material particles, and the coat is an oil film having a cross-linked structure between the anode active material particles adjacent to each other.

29. The battery according to claim 22, wherein the anode active material layer contains an anode active material containing silicon or tin.

30. The battery according to claim 29, wherein the anode active material contains oxygen, and a content of the oxygen in the anode active material is in the range from 3 atomic % to 40 atomic %.

31. The battery according to claim 29, wherein the anode active material contains at least one metal element selected from the group consisting of iron, cobalt, nickel, chromium, titanium, and molybdenum.

32. The battery according to claim 29, wherein the anode active material has an oxygen-containing region containing oxygen in the thickness direction, and a content of the oxygen in the oxygen-containing region is higher than a content of oxygen in other regions.

33. The battery according to claim 22, wherein ten points average height of roughness profile Rz of a surface of the anode current collector is in the range from 1.5 μm to 6.5 μm.

34. The battery according to claim 22, wherein the anode active material layer contains a plurality of anode active material particles.

35. The battery according to claim 34, wherein the anode active material particles have a multilayer structure in the particles.

36. The battery according to claim 34, wherein the anode active material particles are formed by vapor-phase deposition method.

37. The battery according to claim 34, wherein the anode active material layer contains a metal not being alloyed with an electrode reactant.

38. The battery according to claim 37, wherein the anode active material layer has the metal in a gap between the anode active material particles adjacent to each other.

39. The battery according to claim 37, wherein the anode active material layer has the metal in at least part of an exposed face of the anode active material particles.

40. The battery according to claim 37, wherein the anode active material particles have a multilayer structure in the particles, and the anode active material layer has the metal in a gap in the anode active material particles.

41. The battery according to claim 37, wherein the metal contains at least one metal element selected from the group consisting of iron, cobalt, nickel, zinc, and copper.

42. The battery according to claim 37, wherein ratio M2/M1 of the number of moles M2 per unit area of the metal in relation to the number of moles M1 per unit area of the anode active material particles is in the range from 1/15 to 7/1.

43. The battery according to claim 37, wherein the metal is formed by liquid-phase deposition method.

44. The battery according to claim 22, wherein the electrolytic solution contains a solvent containing sultone.

45. The battery according to claim 44, wherein the sultone is 1,3-propene sultone.

46. The battery according to claim 22, wherein the electrolytic solution contains a solvent containing a cyclic ester carbonate having an unsaturated bond.

47. The battery according to claim 46, wherein the cyclic ester carbonate having an unsaturated bond is vinylene carbonate or vinylethylene carbonate.

48. The battery according to claim 22, wherein the electrolytic solution contains a solvent containing fluorinated ester carbonate.

49. The battery according to claim 48, wherein the fluorinated ester carbonate is difluoroethylene carbonate.

50. The battery according to claim 22, wherein the electrolytic solution contains an electrolyte salt containing boron (B) and fluorine (F).

51. The battery according to claim 50, wherein the electrolyte salt is lithium tetrafluoroborate (LiBF₄).

52. The battery according to claim 22, wherein the cathode, the anode, and the electrolytic solution are contained in a cylindrical or square package member.

53. The battery according to claim 52, wherein the package member contains iron or an iron alloy.
